(19) United States
(12) Patent Application Publication
(10) Pub. No.: US 2024/0326296 A1
(43) Pub. Date: Oct. 3, 2024

(54) IMPROVED MOLD AND SYSTEM FOR CUSTOMIZING GRIPS

(71) Applicant: Josh Casteel, Norton, OH (US)

(72) Inventor: Josh Casteel, Norton, OH (US)

(21) Appl. No.: 18/191,638

(22) Filed: Mar. 28, 2023

(51) Int. Cl. B29C 33/38; B29C 33/76; B29C 45/26; B33Y 80/00

(52) U.S. Cl. CPC B29C 33/3842; B29C 33/76; B29C 45/261; B29C 45/2673; B33Y 80/00

(57) ABSTRACT

In one or more embodiments, the present invention provides a mold and molding system using 3D-Printed mold inserts for fabricating customized grips for any handlebars, tool handles, golf clubs etc. Use of these 3D printed mold insert allows for rapid and relatively inexpensive preparation of numerous mold forms, and allows formation of shapes that are not possible using standard CNC techniques.

### FIELD OF THE INVENTION

One or more embodiments of the present invention relates to customizable grips. In certain embodiments, the present invention is directed to a molding system for making customized handlebar grips.

### BACKGROUND OF THE INVENTION

Molds for injection molding things like grips are traditionally machined out of metals, a process that is both time consuming and relatively expensive, making it difficult and/or expensive to change mold designs frequently or customize molds. The handlebar grips on dirt bikes, motorcycles, four-wheelers, bicycles, snowmobiles and the like, for example, are prone to wear, particularly when used in racing or off-road. Replacement grips can be purchased, but colors and styles are limited. There have been no readily available ways to customize the new grips for the rider, their sponsor, the track, or other things of interest to the rider without incurring significant tooling costs and even then, it is difficult to get that tooling done quickly.

Recently, various types of additive manufacturing, generally referred to as 3D printing, have emerged as a way of forming computer-designed 3-dimensional structures. While it would be advantageous to design mold forms on a computer and 3D print them, many 3D printed molds have, unfortunately, been found to lack the strength and/or heat tolerance required for repeated injection molding. Common materials used with Fused Deposition Modeling (FDM) 3-D printers, for example, have a low melting point and would not withstand injection molding temperatures. The SLA (stereolithography) 3D printers can withstand the heat and pressure of injection molding, but lack the overall strength of metal molds. Presently, 3D printed molds are also expensive to create, given their size, as a very thick mold is required to hold up to the temperatures and pressures inherent in the injection molding process.

What is needed in the art is a quick method of fabricating customized grips for any handle, golf grip, handlebar or throttle tube that provide for rapid and relatively inexpensive preparation of numerous mold forms, and allows formation of shapes that are not possible using standard CNC techniques.

### SUMMARY OF THE INVENTION

In one or more embodiments, the present invention provides a mold and molding system using 3D-Printed mold inserts for fabricating customized grips for any handlebars, tool handles, golf clubs etc. These mold inserts are preferably prepared by 3D-printing and in various embodiments are prepared using a suitable 3D printable resin that is capable of withstanding the temperatures and pressures that will be used in the injection molding process. In some of these embodiments, the mold insert is formed by generating a set of instructions for 3-D printing a desired structure on a computer and sending those instructions to a suitable 3-D printer. In some of these embodiments, the set of instructions may comprise a 3D modeling or 3D capable computer assisted design (CAD) file generated using suitable computer software that is readable by a suitable 3D printer for printing the resin to be used.

Advantageously, use of these 3D printed mold insert allows for rapid and relatively inexpensive preparation of numerous mold forms, and allows formation of shapes that are not possible using standard CNC techniques. Moreover, these mold inserts generate the outer surface of the grip and will contain most, if not all, of the finer detail in the mold. And as a mold begins to wear under the heat and pressure of repeated use, an identical replacement can be quickly and inexpensively generated by 3D printing. In the same way, back-up copies of a mold insert may be quickly and inexpensively generated by 3D printing and kept in reserve. Another advantage of using the 3D printed mold insert system of the present invention is that it can become economically feasible to prepare personalized and/or custom grips in small numbers since the mold inserts can be quickly and inexpensively generated. Finally, it is envisioned that a user could develop a library of different sets of standard mold inserts, having a variety of textures, shapes, logos, and/or words, allowing the customer to build a desired grip design from the mold inserts in the library.

In a first aspect, the present invention is directed to a system for forming a customized grip comprising: forming a mold for a grip, the mold having a first mold portion and second mold portion, wherein at least one of the first and second mold portions comprises a recessed area sized to receive a 3D printed mold insert reverse textured to form an outer surface of the grip; forming or obtaining a tube sized to fit within the mold, the tube having an inner surface tube and an outer surface upon which the grip is to be molded; designing a mold insert sized to fit within each one of the recessed areas and having an inner surface facing the recessed area of the first or second mold portion and an outer surface reverse textured to form textures, letters, numbers, or designs in or on the surface of the grip using a computer and printing the mold insert from a 3D printable material using a 3D printer; inserting a mold insert into each one of the recessed areas in the first and second mold portions; inserting the tube between the first and second mold portions, closing the mold by joining the first and second mold portions together over the tube thereby forming a cavity in which the grip will form; and injecting a liquid resin under pressure between the outer surface of the tube and the outer surface of the inner mold sections and then cooling or hardening the resin to form the grip.

In some embodiments, the system for forming a customized grip of further comprises an outer mold shell having a first and second outer mold shell half, each having an opening sized to receive one of the first mold portion and second mold portion. In one or more of these embodiments, the system for forming a customized grip of the present invention includes any one or more of the above referenced embodiments of the first aspect of the present invention wherein the outer mold shell is formed of a material selected from the group consisting of steel, aluminum, brass, metals, and combinations and alloys thereof.

In various embodiments, the system for forming a customized grip of the present invention includes any one or more of the above referenced embodiments of the first aspect of the present invention wherein each one of the first mold portion and the second mold portion each comprise a first end plate, a center mold portion and a second end plate. In some embodiments, the system for forming a customized grip of the present invention includes any one or more of the above referenced embodiments of the first aspect of the present invention wherein first mold portion and second mold portion are each secured within the opening in one of a first and second outer mold shell half sized to receive them. In various embodiments, the system for forming a customized grip of the present invention includes any one or more of the above referenced embodiments of the first aspect of the present invention wherein the mold is formed from a material selected from the group consisting of aluminum, steel, brass, plastic, rubber, and combinations or alloys thereof.

In one or more embodiments, the system for forming a customized grip of the present invention includes any one or more of the above referenced embodiments of the first aspect of the present invention wherein both first mold portion and second mold portion have a recessed area sized to receive a 3D printed mold insert which has been reverse textured to form an outer surface of the grip. In some embodiments, the system for forming a customized grip of the present invention includes any one or more of the above referenced embodiments of the first aspect of the present invention wherein the tube is sized to fit over a handlebar and engage a throttle cam on a handle of a vehicle. In one or more embodiments, the system for forming a customized grip of the present invention includes any one or more of the above referenced embodiments of the first aspect of the present invention wherein one of the first mold portion and second mold portion have a recessed area sized to receive a 3D printed inner mold section textured to form an outer surface of the grip and the other of the first mold portion and second mold portion has an inner surface textured to form an outer surface of the grip. In some embodiments, the system for forming a customized grip of the present invention includes any one or more of the above referenced embodiments of the first aspect of the present invention further comprising forming a plurality of inner mold inserts having different textures, letters, numbers, or designs reverse textured their outer surface and selecting desired inner mold sections for use in the step of inserting from the plurality of inner mold sections based upon user preference.

In one or more embodiments, the system for forming a customized grip of the present invention includes any one or more of the above referenced embodiments of the first aspect of the present invention wherein the mold insert is 3D printed from a 3D printable resin comprising a polymer or copolymer selected from the group consisting of thermosetting plastics, liquid photopolymers, UV resins, and a combination thereof.

In one or more embodiments, the system for forming a customized grip of the present invention includes any one or more of the above referenced embodiments of the first aspect of the present invention wherein the resin forming the grip comprises a thermoplastic elastomer or a thermoplastic vulcanite. In some embodiments, the system for forming a customized grip of the present invention includes any one or more of the above referenced embodiments of the first aspect of the present invention wherein the resin forming the grip is a thermoplastic vulcanite comprising ethylene propylene diene monomer rubber (EPDM) and polypropylene. In some embodiments, the system for forming a customized grip of the present invention includes any one or more of the above referenced embodiments of the first aspect of the present invention wherein the step of injecting takes place at a pressure of from about 500 psi to about 20,000 psi. In some embodiments, the step of injecting takes place at a pressure of about 800 psi to about 15,000 psi. In some embodiments, the step of injecting takes place at a pressure of about 1250 psi.

In one or more embodiments, the system for forming a customized grip of the present invention includes any one or more of the above referenced embodiments of the first aspect of the present invention wherein the customized grip has a Shore A hardness of from about 15 to 60. In some embodiments, the system for forming a customized grip of the present invention includes any one or more of the above referenced embodiments of the first aspect of the present invention wherein the polymer used to form the customized grip has a compression set at 100° C. for 22 hours from about 5% to about 65%. In some of these embodiments, the polymer used to form the customized grip has a compression set of 33% at 125° C. after 72 hours.

In one or more embodiments, the system for forming a customized grip of the present invention includes any one or more of the above referenced embodiments of the first aspect of the present invention wherein one or more of the inner mold inserts further comprises a slot sized to receive an interchangeable insert, sized to fit within the slot, the interchangeable insert having a lower surface facing a bottom of the slot and an upper surface substantially contiguous with the inner surface of the one or more of the inner mold portion. In various embodiments, the system for forming a customized grip of the present invention includes any one or more of the above referenced embodiments of the first aspect of the present invention wherein the interchangeable insert is formed by a method selected from molding, casting, 3D printing, routing, engraving, CNC machining, or a combination thereof.

In one or more embodiments, the system for forming a customized grip of the present invention includes any one or more of the above referenced embodiments of the first aspect of the present invention wherein the mold insert is 3D printed from a 3D printable resin comprising a thermosetting plastic, liquid photopolymer, or a UV resin and the tube comprises polypropylene. In some embodiments, the system for forming a customized grip of the present invention includes any one or more of the above referenced embodiments of the first aspect of the present invention wherein the resin used to form the molded grip adheres to the tube when cooled or cured.

In a second aspect, the present invention is directed to a mold for forming customized grips comprising: a first mold half comprising a first outer mold shell and a first inner mold having a first 3D printed mold insert; and a second mold half comprising a second outer mold shell and a second inner mold having a second 3D printed mold insert, wherein the first and second 3D printed mold inserts each have an inner facing surface that is reverse textured to produce a texture or design in the customized grip; and wherein the first and second mold inserts meet when the mold is in a closed arrangement to form the outer surface of the customized grip when resin is injected into the closed mold.

In a third aspect, the present invention is directed to a mold for forming the tube discussed above comprising: a body mold portion for forming the body of the tube, the body mold portion comprising a first body mold side and a second body mold side and having at least one injection port; one or more interchangeable end mold portion for forming a tube end having a desired configuration, each interchangeable end mold portion having a first side and a second side; and a rod or dowel; wherein the first body mold side and the first side of the interchangeable end mold portion are secured together to form a first mold half and the second body mold side and the second side of the interchangeable end mold portion are secured together to form a second mold half; and wherein the dowel is placed between the first mold half and the second mold half and secured together to form a completed mold.

### BRIEF DESCRIPTION OF THE DRAWINGS

For a more complete understanding of the features and advantages of the present invention, reference is now made to the detailed description of the invention along with the accompanying figures in which:

FIG. 1 is an exploded perspective view of one side of a mold for making a handle grip having a 3D printed mold insert according to the present invention.

FIGS. 2A-C are a perspective view (FIG. 2A), top view (FIG. 2B), and back view (FIG. 2C) of the outer mold shell of the handle mold of the present invention.

FIGS. 3A-D are an exploded perspective view (FIG. 3A), side view (FIG. 3B) left perspective view (FIG. 3C), and right perspective view (FIG. 3D) of the inner mold assembly of a handle mold according to one or more embodiments of the present invention.

FIGS. 4A-F are a left perspective view (FIG. 4A), right perspective view (FIG. 4B) front view (FIG. 4C), back view (FIG. 4D), left end view (FIG. 4E), and right end view (FIG. 4F), the central portion of the inner mold assembly of one or more embodiments of the present invention.

FIGS. 5A-F are an outer side view (FIG. 5A), side view (FIG. 5B), inner side view (FIG. 5C), top view (FIG. 5D), left perspective view (FIG. 5E), and right perspective view (FIG. 5F) of the first end piece of the inner mold assembly of one or more embodiments of the present invention.

FIGS. 6A-E are an outer side view (FIG. 6A), a front view (FIG. 6B), an inner side view (FIG. 6C), a left perspective view (FIG. 6D), and a right perspective view (FIG. 6E), of the second end piece of the inner mold assembly according to one or more embodiments of the present invention.

FIGS. 7A-D are a left perspective view (FIG. 7A), right perspective view (FIG. 7B), right end view (FIG. 7C), and left end view (FIG. 7D) of a 3D printed mold insert according to one or more embodiments of the present invention.

FIGS. 8A-B are an exploded perspective view (FIG. 8A) and left perspective view (FIG. 8B) of a second embodiment of the inner mold assembly according to one or more embodiments of the present invention.

FIGS. 9A-C are a front view (FIG. 9A), a back view (FIG. 9B), and a perspective view (FIG. 9C) of the mold insert according to the second embodiment to the present invention having a slot for receiving a second insert for customizing the grip.

FIGS. 10A-D are a front view (FIG. 10A), cross-sectional view (FIG. 10B), left end view (FIG. 10C), and right end view (FIG. 10D) of the second insert for customizing the grip as shown in FIGS. 8A-B and 9A-C.

FIG. 11 is an exploded perspective of one side of a mold according to one or more embodiments of the present invention.

FIG. 12 is an exploded perspective view of one side of a mold for forming a grip according to one or more embodiments of the present invention.

FIG. 13 is an exploded perspective view of one side of a mold assembly according to an embodiment of the present invention that may be used without the outer shell member.

FIG. 14 is an exploded perspective view of an embodiment of the inner mold assembly that may be used without the outer shell member.

FIGS. 15A-D are a side view (FIG. 15A), a longitudinal cross sectional view (FIG. 15B) along the axis R-R in FIG. 15A, and an exploded side view (FIG. 15C), and exploded perspective view (FIG. 15D) of a handlebar grip according to one or more embodiments of the present invention.

FIGS. 16A-C are a side view (FIG. 16A), longitudinal cross-sectional view taken along the T-T axis in FIG. 16A (FIG. 16B), an exploded perspective view (FIG. 16C) of a handlebar assembly and throttle interface according to one or more embodiments of the present invention.

FIG. 17 is an exploded perspective view of an endcap for use with a handlebar grip according to one or more embodiments of the present invention.

FIGS. 18A-B are a front view (FIG. 18A), and side view (FIG. 18B) of the cam for use in interfacing with the throttle of a vehicle.

FIGS. 19A-B are a front view (FIG. 19A), and perspective view (FIG. 19B) of a tube used to form a handle grip according to one or more embodiments of the present invention.

FIGS. 20A-D are a perspective view (FIG. 20A), front view (FIG. 20B), and longitudinal cross-sectional view taken along the axis D-D in FIG. 20B (FIG. 20C) showing a tube forming a handle grip according to one or more embodiments of the present invention having an octagonal end (FIG. 20D) for use in interfacing with the throttle cam of a vehicle;

FIGS. 21A-G are an exploded perspective view of a mold used to form the tube shown in FIGS. 19A-B (FIG. 21A); front view of a first mold half (FIG. 21B), a cross-sectional view of the first mold half of FIG. 21B taken along the axis A-A in FIG. 21B (FIG. 21C); the front view of a second mold half (FIG. 21D), a cross-sectional view taken along the axis B-B in FIG. 21D (FIG. 21E); a front view of the closed mold (FIG. 21F), and a cross-sectional view of the closed mold taken along axis C-C in FIG. 21F (FIG. 21G).

FIGS. 22A-E are a perspective view showing the external features of the closed mold (FIG. 22A), an exploded view of the closed mold of FIG. 22A showing its component parts (FIG. 22B), a front view of one half of the mold of FIG. 22A (FIG. 22C), a front perspective view of one half of the mold of FIG. 22A (FIG. 22D), and a front planer view of a second side of the mold shown in FIG. 22A (FIG. 22E) of a mold used to prepare the tube shown in FIGS. 20A-D.

FIGS. 23A-B are perspective views of a first half (FIG. 23A) and second half (FIG. 23B) of the body portion of the mold shown in FIGS. 22A-E.

FIGS. 24A-E are an outer side view (FIG. 24A), front view (FIG. 24B), inner side view (FIG. 24C), left perspective view (FIG. 24D), and right perspective view (FIG. 24E) of one half of the interchangeable end mold used with the mold shown in FIGS. 22A-E.

### DETAILED DESCRIPTION OF THE ILLUSTRATIVE EMBODIMENTS

The following is a detailed description of the disclosure provided to aid those skilled in the art in practicing the present disclosure. Those of ordinary skill in the art may make modifications and variations in the embodiments described herein without departing from the spirit or scope of the present disclosure. Unless otherwise defined, all technical and scientific terms used herein have the same meaning as commonly understood by one of ordinary skill in the art to which this disclosure belongs. The terminology used in the description of the disclosure herein is for describing particular embodiments only and is not intended to be limiting of the disclosure.

As set forth above, molds for the injection molding of things like grips are traditionally machined out of metals, a process that is both time consuming and relatively expensive, making it difficult and/or expensive to change mold designs frequently or customize molds. In various embodiments, the present invention is directed to a system for forming customized grips using easily interchangeable 3D-printed mold inserts set in one or two metal molds for strength that allow for easy and cost effective customization of grips for various objects, including, but not limited to, handlebar grips for bicycles, motorcycles, ATVs, snowmobiles, watercraft, and other vehicles with handles; tool handles; net handles, car jack handles, angle grinder handles, golf grips, and similar objects with handles.

In some of these embodiments, the present invention is directed to a mold for a grip having: a first outer shell portion and second outer shell portion formed from steel, aluminum, brass, or similarly sturdy material wherein the first and second shell portions comprise a recessed area sized to receive a first and second mold portion, respectively; a first and second mold portion wherein at least one of the first and second mold portions comprises a recessed area sized to receive a 3D printed mold insert textured to form an outer surface of the grip; a tube sized to fit within said outer mold, said tube having an inner surface and an outer surface upon which the grip is to be molded; at least one 3D printed mold insert sized to fit within one of the recessed areas in the first and second mold portions and having an inner surface facing the recessed area and an outer surface reverse textured to form textures, letters, numbers, or designs in or on the surface of the grip designed and 3D-printed using a computer. As used herein, “reversed textured” as applied to a mold surface means that the surface has a texture and/or structure that is the negative of the desired texture and/or structure so that the molded surface will have the desired structure or texture.

In another aspect, the present invention is directed to a system or method for forming customized grips comprising: forming a mold for a grip, said mold having a first mold portion and second mold portion, wherein at least one of said first and second mold portions comprises a recessed area sized to receive a 3D printed mold insert textured to form an outer surface of the grip; forming or obtaining a tube sized to fit within said outer mold, said tube having an inner surface and an outer surface upon which the grip is to be molded; designing a mold insert sized to fit within each one of said recessed areas and having an inner surface facing the recessed area of said first or second mold portion and an outer surface reverse textured to form textures, letters, numbers, or designs in or on the surface of the grip using a computer and printing said mold insert from a 3D printable material using a 3D printer; inserting an inner mold section into each one of said recessed areas in said first and second mold portions; inserting said tube between the first and second mold portions, closing the mold by joining first and second mold portions together over said tube thereby forming a cavity in which the grip will form; and injecting a liquid resin under pressure between the outer surface of said tube and the outer surface of said inner mold sections and then cooling or hardening the resin to form the grip.

In yet another aspect, the present invention is directed to a mold for forming a tube for forming an injection molded grip comprising: a body mold portion for forming the body of the tube, said body mold portion comprising a first body mold side and a second body mold side and having at least one injection port; one or more an interchangeable end mold portion for forming a tube end having a desired configuration, each interchangeable end mold portion having a first side and a second side; and a rod or dowel; wherein said first body mold side and said first side of said interchangeable end mold portion are secured together to form a first mold half and said second body mold side and said second side of said interchangeable end mold portion are secured together to form a second mold half; and wherein the dowel is placed between said first mold half and said second mold half and secured together to form a completed mold.

The following terms may have meanings ascribed to them below, unless specified otherwise. As used herein, the terms “comprising” “to comprise” and the like do not exclude the presence of further elements or steps in addition to those listed in a claim. Similarly, the terms “a,” “an” or “the” before an element or feature does not exclude the presence of a plurality of these elements or features, unless the context clearly dictates otherwise. Further, the term “means” used many times in a claim does not exclude the possibility that two or more of these means are actuated through a single element or component.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein in the specification and the claim can be modified by the term “about.”

It should be also understood that the ranges provided herein are a shorthand for all of the values within the range and, further, that the individual range values presented herein can be combined to form additional non-disclosed ranges. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50.

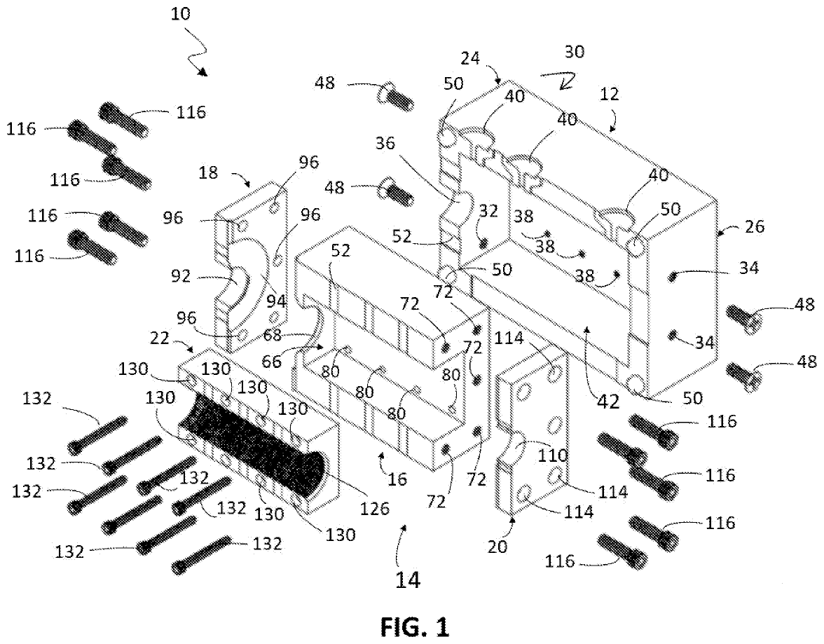

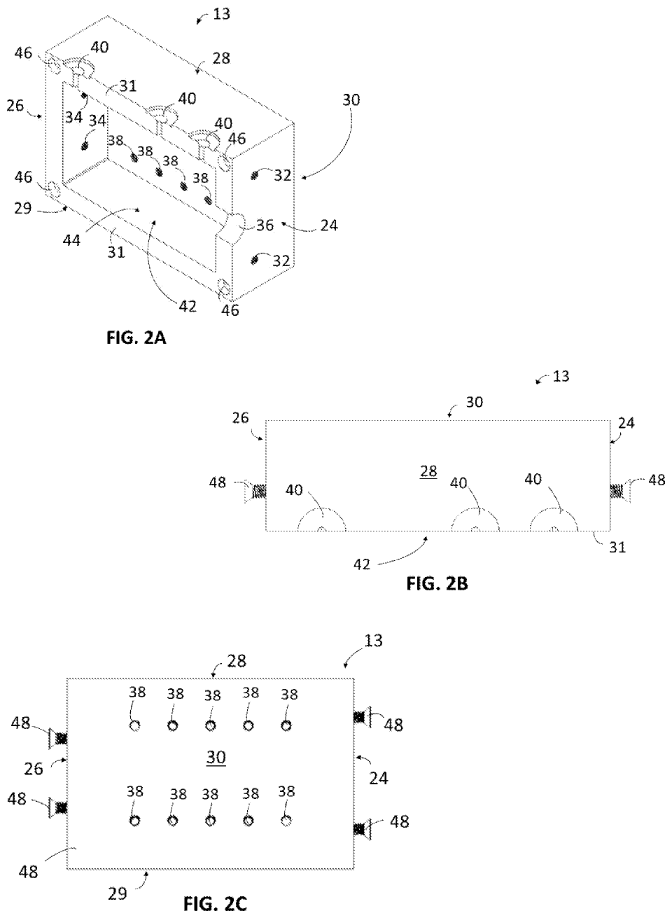

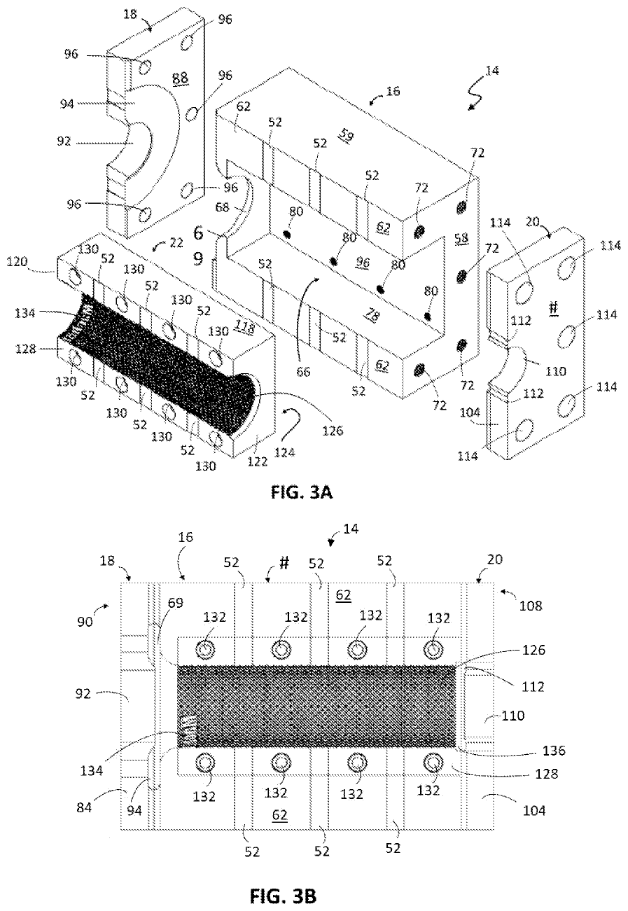

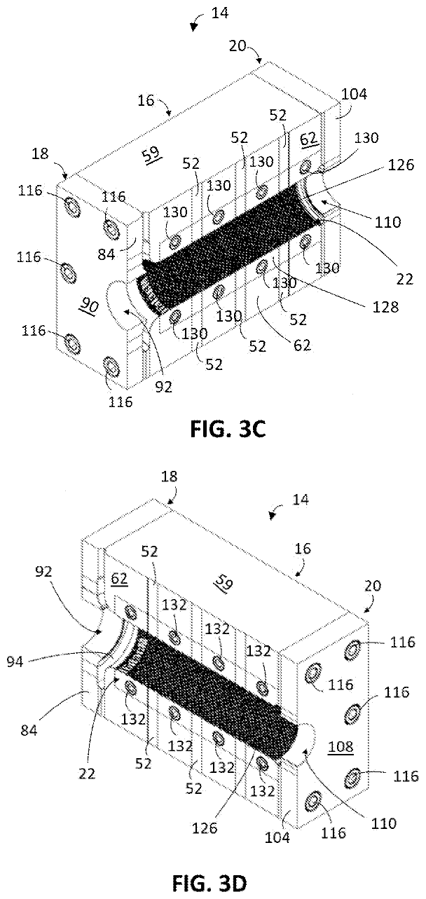

In a first aspect, the present invention is directed to a mold for forming grips for use with handlebars and other objects, as described above. Referring now to FIG. 1, one side of a handle mold according to one or more embodiments of the present invention is shown, generally indicated by the number 10. As will be understood, the mold further comprises a second half (not shown), which is used to mold the other half of the grip and is generally, but not always, a mirror image of what is shown in FIG. 1. Grip mold 10 includes an outer shell 12 and an inner mold assembly 14. Outer shell 12 provides additional stability to inner mold assembly 14 during the injection molding process and is shown in more detail in FIGS. 2A-C. An inner mold assembly 14 according to various embodiments of the present invention is shown in more detail in FIGS. 3A-D, 4A-F, 5A-F, 6A-E, 7A-D, 8A-B, 9A-C, 10A-D, 11, and 12. In one or more embodiments, inner mold assembly 14 comprises a center portion 16, a first end plate 18, a second end plate 20, and a mold insert 22.

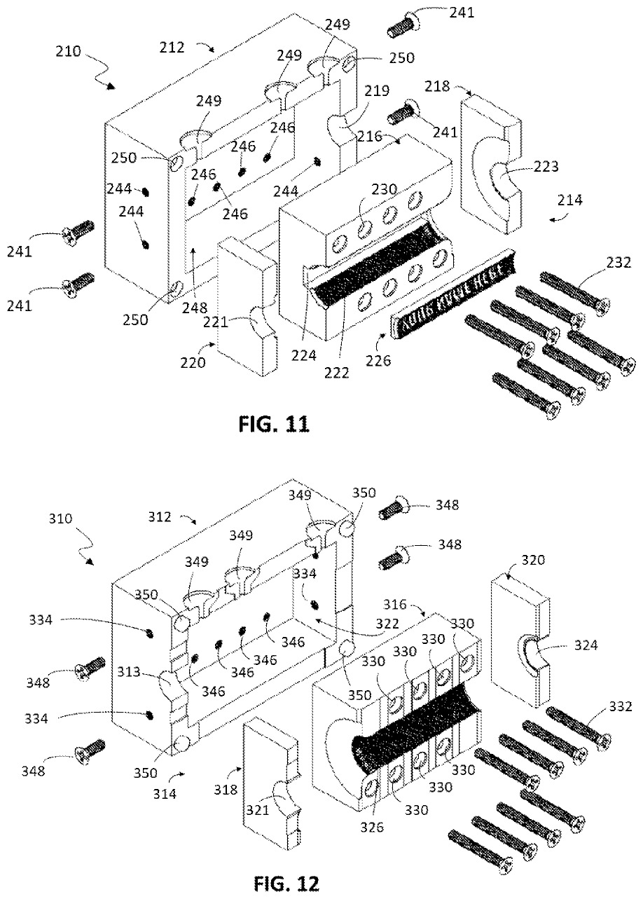

Turning first to the outer shell as shown in FIGS. 1 and 2A-C, outer shell 12, 13 has a first end 24, a second end 26, a top surface 28, a bottom surface 29, a back surface 30 and a front surface 31. As will be appreciated, the outer shell 12 as shown in FIGS. 2A-C is one-half of the actual mold and will be joined by the corresponding outer shell portion 12 of the mold shown in FIG. 1 to form the full outer shell mold. First end 24 of outer shell 12 comprises threaded openings 32 and a semi-circular recess 36, which is configured to receive a rod, dowel, tube or other object upon which the handle is to be molded (not shown). Second end 26 comprises threaded openings 34. Similarly, back surface 30 of outer shell 12 comprises a plurality of threaded openings 38 which are shown in FIG. 2C arranged in two parallel rows. Top surface 28 of outer shell 12 further comprises a plurality of injection port openings thorough which the resin is inserted under pressure into the mold. Outer shell 12 contains a central cavity 42 sized to receive the inner mold assembly described below. Screws 48 are sized to be received by threaded openings 32 and 34 and are used to hold the inner mold assembly in place within outer shell 12, particularly during the injection process. Finally, each one of the alignment openings 46 is sized to meet with and receive a corresponding post 50 in the other half of the outer shell mold (see, e.g., FIGS. 1, 12) to ensure alignment and prevent lateral movement of the two halves of the mold relative to each other when the mold is closed. In various embodiments, outer shell may also include one or more air vents 52, to allow air to escape during the molding process.

As will be apparent, outer shell 12 supports the inner mold assembly 14 during the injection molding process and may be made out of any sturdy material, but is preferably constructed from metal, steel, brass, iron, aluminum, or other strong materials. As will be appreciated the strength of the material will be dependent upon the thickness of the mold, with softer materials requiring thicker walls. Outer shell 12 may be fabricated using any suitable method including, but not limited to, welding, grinding, milling, CNC machining, metal 3D printing such as selective laser sintering (SLS) 3D printing, casting, or a combination thereof. In some embodiments, Outer shell 12 is fabricated from aluminum using a computer numerical control (CNC) milling machine.

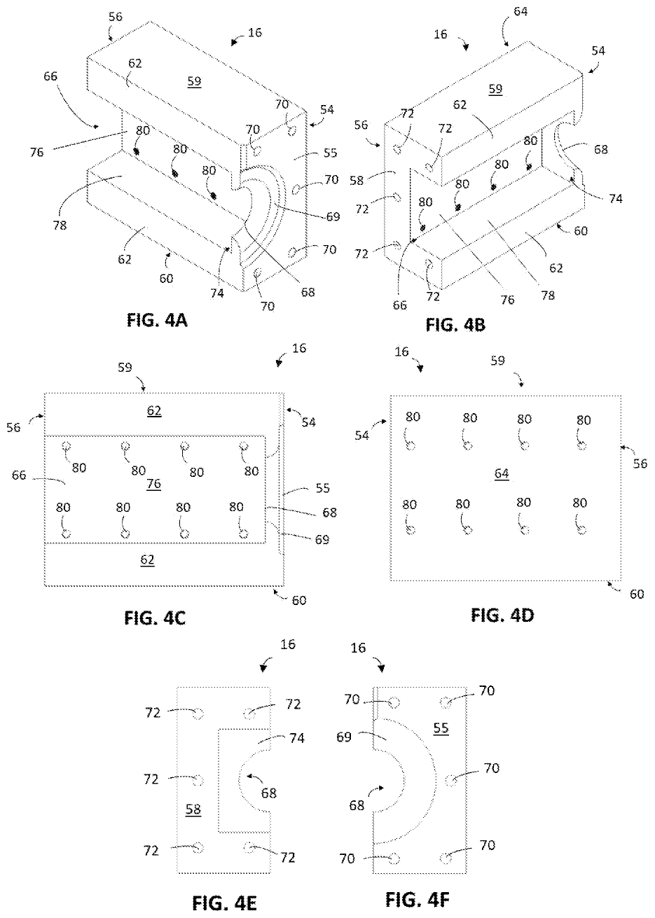

The inner mold assembly 14 according to one or more embodiments of the inventions is shown in more detail in FIGS. 3A-D. As set forth above, inner mold assembly 14 comprises a center portion 16, a first end plate 18, a second end plate 20, and a 3D printed mold insert 22 and is sized to be received within central cavity 42 of the outer shell 12. One embodiment of center portion 16 of inner mold assembly 14 is shown in detail in FIGS. 4A-F. As shown in these figures, center portion 16 has a first end 54, having a first end outer surface 55, a second end 56, having a second end surface 58, a top surface 59, a bottom surface 60, a front surface 62 and a back surface 64. In some other embodiments, front surface 62 of center portion 16 will comprise one or more air vents 52 (See, FIGS. 1 and 3A-D), to allow air displaced during the molding process to escape. Generally, at least one half of the inner mold assembly will have air vents 52. Turning back to FIGS. 4A-D, first end 54 of center portion 16 further comprises a semi-circular recess 68 in an inner flange mold form 69, and a plurality of threaded openings 70. Similarly, second end 56 has a second end surface 58 and has a plurality of threaded openings 72.

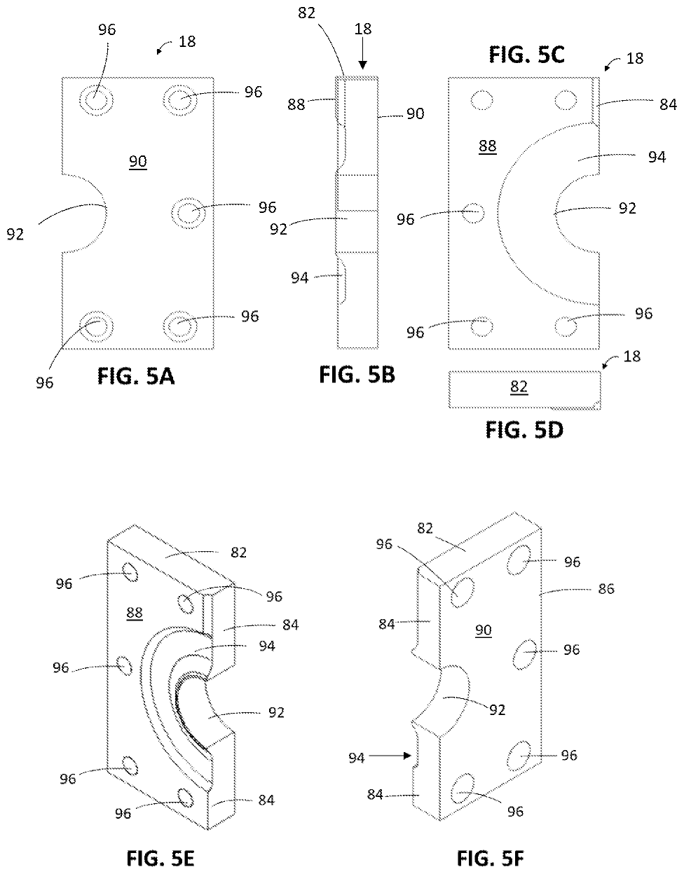

Center portion 16 further comprises an inner cavity 66 sized to receive the mold insert 22. Turning again to FIGS. 4A-F, it can be seen that the inner cavity 66 has a first end surface 74, a bottom surface 76, and two side surfaces 78. Bottom surface 76 of inner cavity 66 further comprises a series of holes 80 that are aligned coaxially with threaded openings 38 of the outer shell 12. In the embodiments shown in the figures, inner cavity 66 is a generally rectangular opening in center portion 16. The first end plate 18 according to one or more embodiments of the present invention is shown in FIGS. 5A-F. As can be seen, first end plate 18 has a top surface 82, a front surface 84, a back surface 86, an inner side surface 88, an outer side surface 90, a semi-circular recess 92, an outer flange mold form 94 and a plurality of openings 96.

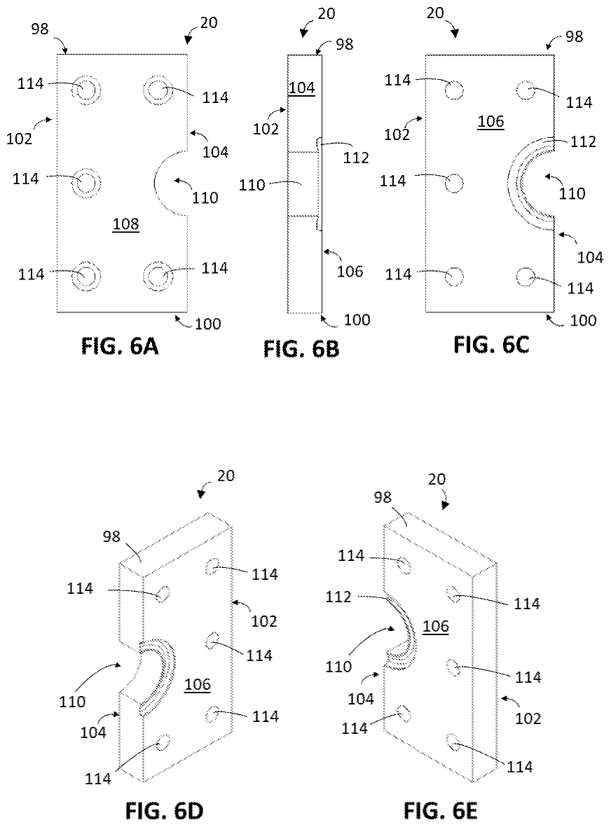

The second end plate is shown in more detail in FIGS. 6A-E. Second end plate 20 has a top surface 98 a bottom surface 100, back surface 102, front surface 104 an inner side surface 106, an outer side surface 108, a semi-circular recess 110, an inner flange mold form 112 and a plurality of openings 114. As can be seen, first end plate 18 is secured to the first end of center portion 16 by bolts 116 (FIG. 1) inserted through openings 96 and in to threaded openings in first surface 55 of center portion 16, similarly second end plate 20 is secured to the second end 56 of center portion 16 by a plurality of bolts 116 inserted through opening 114 and in to threaded openings 72 and second surface 58 of center portion 16. It should be appreciated, however, that the mechanism for holding first end plate 18 and second end plate 20 to center portion 16 is not particularly limited and any suitable mechanical fastener or combination thereof, may be used. In some embodiments, for example, bolts 116 may pass through aligned openings in holding first end plate 18, second end plate 20, and center portion 16 be received by, and secured through, one or more threaded nuts. In some other embodiments, bolts 116 will pass through openings in the first end plate 18 and center portion 16 and be received by, and secured through, threaded openings in second end plate 20. Conversely, in some other embodiments, bolts 116 will pass through openings in the second end plate 20 and center portion 16 and be received by, and secured through, threaded openings in first end plate 18

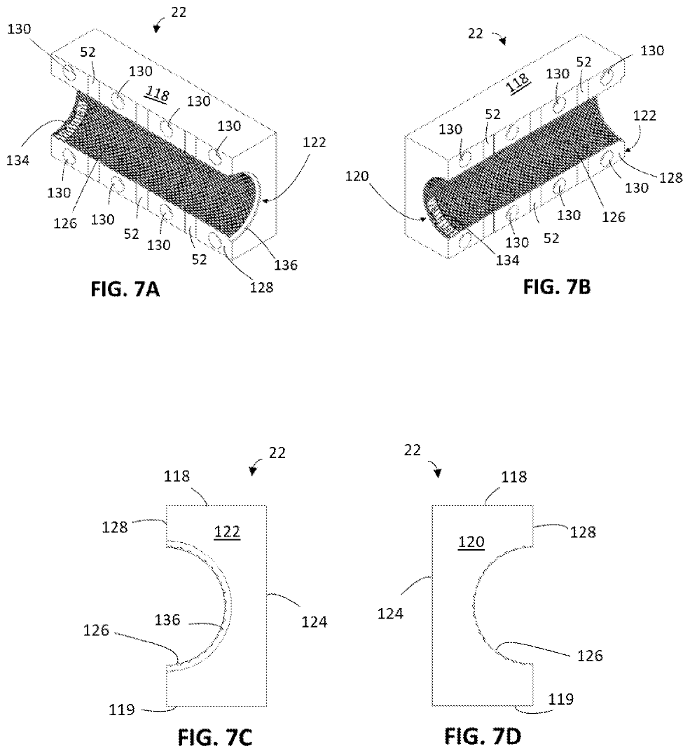

Mold insert 22 is sized to fit within inner cavity 66 of center portion 16 and is shown in detail FIGS. 7A-D. Mold insert 22 has a top surface 118, bottom surface 119, a first end surface 120, a second end surface 122, a back surface 124, mold surface 126, front surface 128 and a plurality of openings 130 sized to receive bolts 132. In the embodiments shown in FIGS. 7A-D, the second end surface contains an inner flange mold form 136. In some embodiments inner mold form 126, which forms the outer surface of the grip, may optionally contain numbering, designs, letters, and such 134.

As set forth above, mold insert 22 is preferably prepared by 3D-printing and in various embodiments is prepared using a suitable 3D printable resin that capable of withstanding the temperatures and pressures that will be used in the injection molding process. Advantageously, use of a 3D printed mold insert allows for the rapid and relatively inexpensive preparation of numerous mold forms and allows for shapes that are not possible using standard CNC techniques. Moreover, mold insert 22 generates the outer surface of the grip and will contain most, if not all, of the finer detail in the mold. And as a mold begins to wear under the heat and pressure of repeated use, an identical replacement can be quickly and inexpensively generated by 3D printing. In the same way, back-up copies of a mold insert 22 may be quickly and inexpensively generated by 3D printing and kept in reserve. Another advantage of using the 3D printed mold insert 22 system of the present invention is that it can become economically feasible to prepare personalized and/or custom grips in small numbers since the mold inserts can be quickly and inexpensively generated. Finally, it is envisioned that a user could develop a library of different sets of standard mold inserts, having a variety of textures, shapes, logos, and/or words, allowing the customer to build a desired grip design from the mold inserts in the library.

In some of these embodiments, mold insert 22 may be formed by first generating a set of instructions for 3-D printing a desired structure and sending those instructions to a suitable 3-D printer. In some of these embodiments, the set of instructions may comprise a 3D modeling or 3D capable computer assisted design (CAD) file generated using suitable computer software that is readable by a suitable 3D printer for printing the resin to be used. In some embodiments, the design files may be created using commercially available software such as SolidWorks™ (Dassault Systems SolidWorks Corp., Waltham, MA), Fusion 360™ (Autodesk Inc., San Francisco, CA), and/or proprietary software provided with the 3D printer being used. In some embodiments, the CAD models may be sliced digitally into layers using the 3D printer's software suite prior to manufacturing.

The type of 3D printer used is not particularly limited and any 3D printer capable of printing the selected resin to form a mold insert having sufficient fidelity to the CAD design being printed. Suitable methods for 3D printing the mold insert may include, without limitation, 3D printed using fused deposition modeling (FDM), Micro 3D Printing, Stereolithography (SLA), liquid crystal display (LCD), digital light processing (DLP), continuous digital light processing (cDLP), micro-stereolithography (μSLA), selective laser sintering (SLS), laser powder bed fusion (LPBF), electron beam melting (EBM), material Jetting (MJ), nanoParticle Jetting (NPJ), Metal Binder Jetting, Polymer Binder Jetting, Sand Binder Jetting, Laminated Object Manufacturing (LOM), Ultrasonic Consolidation (UC), Powder Laser Energy Deposition, Wire Arc Additive Manufacturing (WAAM), Wire Electron Beam Energy Deposition, and combinations thereof. In some embodiments, the mold insert is 3D printed using a stereolithography (SLA) based 3D printer. As will be understood by those of skill in the art, in stereolithography (SLA) based 3D printing, an ultraviolet laser is used to cure a photosensitive resin layer by layer to produce a 3D object. In some embodiments, the mold insert is 3D printed using a Formlabs™ Form 2 3D Printer.

In some other embodiments, the mold insert is 3D printed from metal using conventional techniques for printing metals, such as selective laser sintering (SLS), Wire Arc Additive Manufacturing (WAAM), Wire Electron Beam Energy Deposition, Micro 3D Printing, Metal Binder Jetting, metal lithography, fused deposition modeling with metal filament (FDM/Extrusion), selective laser melting or powder bed fusion with laser (SLM/PBF), electron beam melting or powder bed fusion with electron beam (EBM/PBF), directed energy deposition (DED laser), directed energy deposition (electron beam) DED eBeam and combinations thereof.

As will be apparent, the resin chosen to form the mold insert will depend in part upon the particular type of 3D printer being used, but is not otherwise limited provided that it can be 3D printed into a mold insert having sufficient hardness, compression strength, heat resistance, and dimensional accuracy for use in injection molding. Further, the resin chosen to form the mold insert should not bond with, react with, denature, or otherwise affect the appearance or performance of the resins used to form the grips.

In some embodiments, the resin will comprise a thermosetting plastic suitable for SLA 3D printing. In some embodiments, the resin may be Formlabs™ “Tough” resin (Formlabs™ Inc. (Summerville, MA)), Formlabs™ “Rigid 10K” resin (Formlabs™ Inc. (Summerville, MA)), Formlabs™ “High Temp” resin (Formlabs™ Inc. (Summerville, MA)) Formlabs™ “Grey Pro” resin (Formlabs™ Inc. (Summerville, MA)), Somos™ Perform resin (DSM Desotech Inc., Elgin IL), or a combination thereof. In some other embodiments, the resin will comprise an acetonitrile butadiene styrene (ABS) polymer suitable for 3D printing by Material Jetting, such as Digital ABS Plus resin commercially available from Stratasys, Ltd. (Eden Prairie, MN). In some other embodiments, the resin will comprise a photocrosslinkable polymer.

After the selected design has been 3D printed into a mold insert, it will preferably be post-cured as outlined by the manufacturer of the resin and/or the manufacturer of the 3D printer used. In some embodiments, the 3D printed mold insert will be cured by additional exposure to UV light, additional heating, or both additional UV light and additional heating. In various embodiments, the 3D printed mold insert may be post-cured by irradiating it with UV light at a temperature of from about 60° C. to about 90° C. for from 15 to about 130 min, depending upon the particular polymer resin used. In some embodiments, the mold insert may be post cured using the Form Cure™ device commercially available from Formlabs™ Inc., (Summerville, MA).

In various embodiments, the 3D printed mold insert will have an Ultimate Tensile Strength (UTS) of from about 45 MPa to about 80 MPa after curing as measured by ASTM D638-14.

In various embodiments, the 3D printed mold insert will have a Shore D hardness of from about 85 to about 100 after curing by heat and/or UV light, as measured by ASTM D2240. In some embodiments, the 3D printed mold insert will have a Shore D hardness of from about 90 to about 95 after curing as measured by ASTM D2240.

In various embodiments, the 3D printed mold insert will have a flexural strength of from about 90 MPa to about 130 MPa after curing as measured by ASTM D790-15. In some embodiments, the 3D printed mold insert will have a flexural strength of from about 90 MPa to about 130 MPa, in other embodiments, from about 90 MPa to about 120 MPa, in other embodiments, from about 90 MPa to about 100 MPa, in other embodiments, from about 95 MPa to about 130 MPa, in other embodiments, from about 100 MPa to about 130 MPa, in other embodiments, from about 110 MPa to about 130 MPa, in other embodiments, from about 120 MPa to about 30 MPa, and in other embodiments, from about 95 MPa to about 105 MPa, after curing as measured by ASTM D790-15. In some embodiments, the mold insert has a flexural strength after post curing with heat and UV light of from about 95 MPa to about 125 MPa, as measured by ASTM D790-15.

In one or more embodiments, the 3D printed mold insert will have a flexural strength at break of from about 90 MPa to about 105 MPa after curing as measured by ASTM D790-15. In some embodiments, the 3D printed mold insert will have a flexural strength at break of from about 90 MPa to about 100 MPa, in other embodiments, from about 90 MPa to about 95 MPa, in other embodiments, from about 95 MPa to about 105 MPa, in other embodiments, from about 100 MPa to about 105 MPa, and in other embodiments, from about 95 MPa to about 100 MPa after curing as measured by ASTM D790-15. In some of these embodiments, the 3D printed mold insert will have a flexural strength at break of about 97 MPa.

In various embodiments, the 3D printed mold insert will have a flexural stress at 5% strain of from about 80 MPa to about 100 MPa after curing as measured by ASTM D790-15. In some embodiments, the 3D printed mold insert will have a flexural stress at 5% strain of from about 80 MPa to about 100 MPa, in other embodiments, from about 80 MPa to about 95 MPa, in other embodiments, from about 80 MPa to about 90 MPa, in other embodiments, from about 85 MPa to about 105 MPa, in other embodiments, from about 90 MPa to about 100 MPa, in other embodiments, from about 90 MPa to about 105 MPa, in other embodiments, from about 95 MPa to about 105 MPa, in other embodiments, from about 80 MPa to about 90 MPa, and in other embodiments, from about 85 MPa to about 90 MPa after curing as measured by ASTM D790-15. In some of these embodiments, the 3D printed mold insert will have a flexural stress at 5% strain of about 86 MPa after curing as measured by ASTM D790-15.

In various embodiments, the 3D printed mold insert will have a flexural modulus of from about 2 GPa to about 12 GPa after curing as measured by ASTM D790-15. In some embodiments, the 3D printed mold insert will have a flexural modulus of from about 2 GPa to about 10 GPa, n other embodiments, from about 2 GPa to about 8 GPa, in other embodiments, from about 2 GPa to about 6 GPa, in other embodiments, from about 2 GPa to about 4 GPa, in other embodiments, from about 2 GPa to about 3 GPa, in other embodiments, from about 3 GPa to about 12 GPa, in other embodiments, from about 5 GPa to about 12 GPa, in other embodiments, from about 7 GPa to about 12 GPa, and in other embodiments, from about 9 GPa to about 12 GPa after curing as measured by ASTM D790-15.

In various embodiments, the 3D printed mold insert will have a heat deflection temperature at 0.45 MPa of from about 160° C. to about 460° C. after curing as measured by as measured by ASTM D648-16. In some embodiments, the 3D printed mold insert will have a heat deflection temperature at 0.45 MPa of from about 180° C. to about 460° C., in other embodiments, from about 200° C. to about 460° C., in other embodiments, from about 250° C. to about 460° C., in other embodiments, from about 300° C. to about 460° C., in other embodiments, from about 350° C. to about 460° C., in other embodiments, from about 400° C. to about 460° C., in other embodiments, from about 160° C. to about 400° C., in other embodiments, from about 160° C. to about 300° C., and in other embodiments, from about 160° C. to about 200° C. after curing as measured by as measured by ASTM D648-16.

In various embodiments, the 3D printed mold insert will have a maximum heat deflection temperature (HDT) of from about 150° C. to about 460° C. after curing. In some embodiments, the 3D printed mold insert will have a maximum HDT of from about 180° C. to about 460° C., in other embodiments, from about 200° C. to about 460° C., in other embodiments, from about 250° C. to about 460° C., in other embodiments, from about 300° C. to about 460° C., in other embodiments, from about 350° C. to about 460° C., in other embodiments, from about 400° C. to about 460° C., in other embodiments, from about 160° C. to about 400° C., in other embodiments, from about 160° C. to about 300° C., and in other embodiments, from about 160° C. to about 200° C. after curing.

While center portion 16, first end plate 18, second end plate 20 can also be fabricated by 3D printing as set forth above, they are preferably fabricated from a metal, such as aluminum, steel or brass since these materials are more durable and are not typically customized. It is preferred that the outer shell 12 be metal.

In some embodiments, inner mold assembly 14 may be constructed as shown in FIG. 1 and FIGS. 3A-D. As will be apparent, the molds shown in these figures are intended for forming a handlebar grip for use with a bicycle or a motorcycle but the invention is not so limited and other types of handles may be constructed using molds similar to those shown. As set forth above, the first end plate 18 and second end plate 20 are secured to the center portion 16 by a plurality of bolts 116 as will also be apparent from FIG. 1 and as can be seen in FIGS. 3A-D the mold insert 22 and the center portion of mold assembly 16 are secured to outer shell 12 by means of bolts 132 which are inserted through holes 130 in the mold insert 22 and holes 80 in the center portion 16, and then received by the threaded openings 38 in the outer shell 12. As can be seen, inner flange form 69 in center portion 16 and outer flange mold form 94 in first end plate 18, together form the inner flange mold for the grip. Similarly, inner flange mold form 112 of the second end plate 20, together with the inner flange mold form 136 in mold insert 22, form the outer flange of the grip.

As will be apparent to those of ordinary skill in the art, steps should be taken to ensure that the various parts of the mold described above do not move when the resin is injected and pressure is applied during the molding process. In the embodiment shown in FIGS. 1, 3A-D, 4A-F, 5A-F, 6A-E, 7A-D, 8A-B, and 9A-D, and inner mold assembly 14 is held together by bolts 116 running through first end plate 18 and second end plate 20 and into threaded openings 70 and 72, and is sized to fit within the central cavity 42 in outer shell 12. To ensure a good fit, the holes 96 in the outer surface 90 of the first end plate 18 and holes 114 in the outer surface 108 of the second end plate 20 are all recessed and the length of bolds 116 calculated to ensure that the ends of bolts 116 do not extend outwardly from the ends of the inner mold assembly 14 and interfere with its fit within the central cavity 42 in outer shell 12. In these embodiments, inner mold assembly 14 is held in place by bolts 48 running through threaded openings 32 and 34 and by bolts 132 running through holes 130 in mold insert 22 and holes 80 in the center portion 16 of inner mold assembly 14 and then into threaded openings 38 in the outer shell 12, thereby ensuring that the inner mold assembly does not move during the molding process. It may, in some embodiments, be necessary to have holes 130 and 80 be slotted so that the entire assembly 14 can be slid left/right in the cavity 42 using bolts 48. This allows for some play and helps align the two sides of the molds before tightening them to the shell 12 using bolts 132.

It should be appreciated, however, that the mechanism for holding mold insert 22 to inner mold assembly 14 and outer shell 12 is not particularly limited and any suitable mechanical fastener or combination thereof, may be used. In some embodiments, for example, threaded openings 38 in the outer shell 12 will be unthreaded and pass all the way through outer shell 12. In these embodiments, the threaded ends of bolts 132 may be received by, and secured through, one or more threaded nuts, and optionally one or more washer. In some other embodiments, bolts 132 may be configured to pass through holes 130 in mold insert 22 to be received by threaded openings in the center portion 16 and center portion 16 secured to shell 12 by some other means.

As will be understood by those of ordinary skill in the art, the injection molding process used by the present invention requires two matching mold halves. In various embodiments, a least one mold half may be configured substantially as shown in FIG. 1 and described above. In these embodiments, at least one mold half will comprise a 3D printed mold insert 22 as shown in FIGS. 1, 3A-D, 7A-C, 8A-B, and 9A-C. In most embodiments, the second mold half (not shown) will be a mirror image of what is shown in FIG. 1, but this need not be the case. It must, however, be matching in the sense that when aligned and clamped together, the two mold halves form a complete mold for the desired grip. In some embodiments, the second mold half may be configured as shown in FIG. 11 or FIG. 12. In some embodiments, the texture applied by both mold halves will be the same, but again this need not be the case and the two mold halves may apply completely different textures, logos, etc. to the grip. In some embodiments, the inner and outer flanges may be asymmetrical, in which cases the two mold halves will be different.

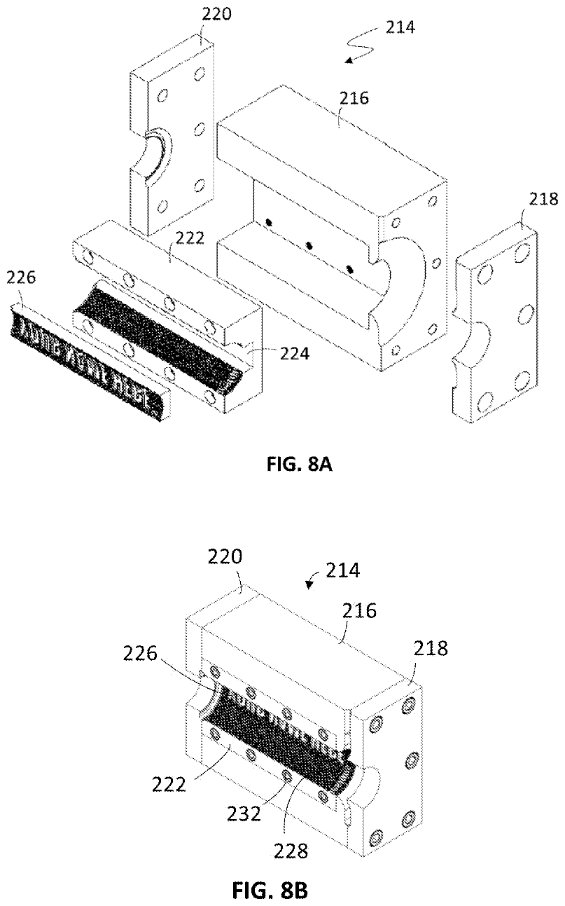

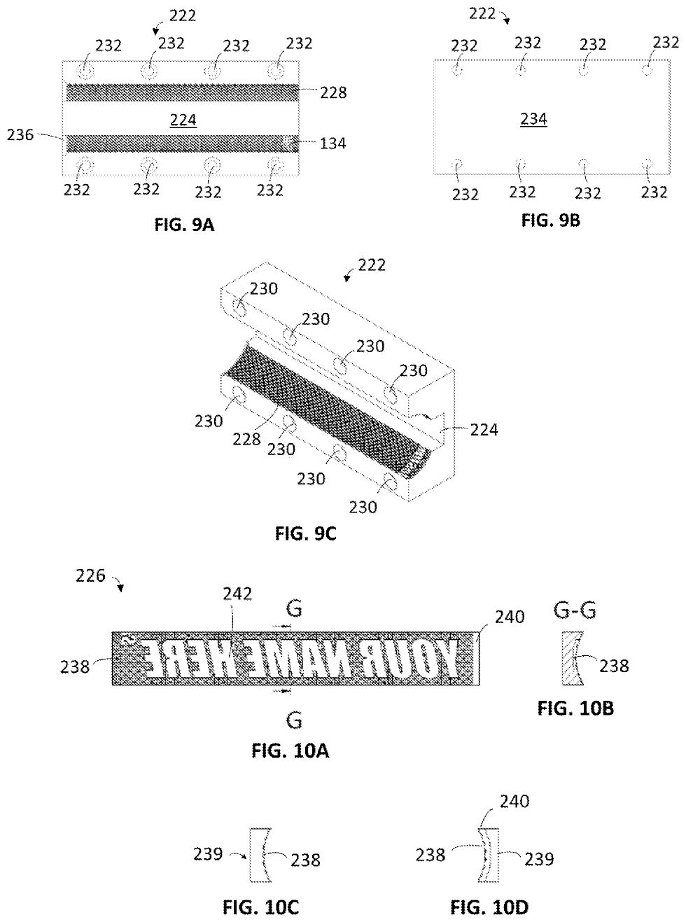

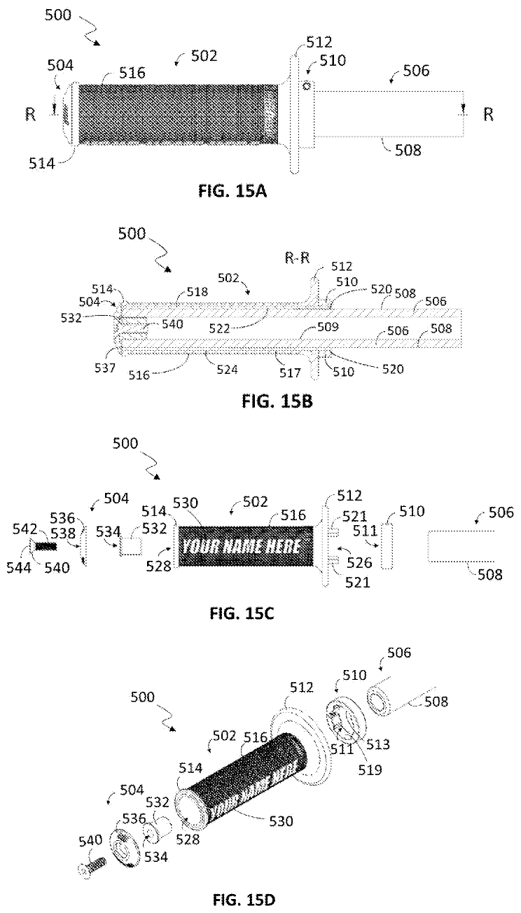

In some embodiments, the apparatus shown in FIGS. 1-10 is a mold for making a textured bicycle or motorcycle handlebar grip over a plastic tube (See FIGS. 15A-D and 16A-C), as described below. In some of these embodiments, a rod or dowel (not shown) is inserted through the tube upon which the grip is to be molded to help keep the tube from losing its shape during the molding process. The rod or dowel is held in place between semicircular recess 110 and a similar structure on the opposing mold half. The tube upon which the grip is molded abuts the second mold end plate 20 and does not extend into semicircular recesses 110. As a result, the grips produced are open ended and have a clean, flush outer ends without cutting. The open ended feature of the grips is a feature of the grips of the present invention. The other end of the tube, however, does extend part way or all of the way into semicircular recess 92, where it is clamped between semicircular recess 92 and a similar structure on the opposing mold half. In some embodiments the dowel or rod (not shown), tube, or other subject upon which the grip is to be molded, may extend into or through semicircular recess 36 in the outer shell 12. Because the tube used in FIGS. 1-9 is circular in cross section, the recesses 92 and 110 are described herein as “semicircular,” but the invention is not to be so limited. As should be apparent, these recesses can be any shape necessary to hold a rod and tube or any other object upon which the grip is to be molded. While also referred to as a “semicircular recess,” semicircular recess 68 in center portion 16 is part of the mold form for the inner flange and are not used to support the tube or the rod or dowel carrying the tube.

FIGS. 11 and 12 show corresponding halves 210, 310 of a mold for generating a textured bicycle or motorcycle handlebar grip according to an alternative embodiment of the present invention. The mold half 210 shown in FIG. 11 comprises an outer shell 212 substantially as shown in FIGS. 2A-C, an inner mold 214 having a center portion 216, a first end plate 218, a second end plate 220, and a customized insert 226 configured to be received in slot 224 of center portion 216. Center portion 216 comprises textured inner surface 222, slot 224, and holes 230, as shown. Customized insert 226 has a back side 239 and a textured front side which may contain customized text, textures logos etc. and is substantially flush with the textured inner surface 222 of center portion 216. In various embodiments, customized insert 226 may be formed using any suitable method, as set forth above. In some of these embodiments, center portion 216 may be formed using 3D printing. Outer shell 212 side comprises threaded openings 244, which are sized to receive bolts 241, bottom threaded openings 246 which are sized to receive bolts 232, injection ports 249, and alignment holes 250.

In these embodiments, the center portion 216 of inner mold assembly 214 is a single piece and the customized insert 226, if present, is received within a slot 224 in the center portion 216 rather than a separate mold insert as shown in FIG. 1 above. Also, in these embodiments, the inner mold assembly 214 is not secured together with bolts as shown in FIGS. 1, 3C-D, and 8A-B before being inserted into central opening 248. Instead, the first end plate 218 and second end plate 220 are held in place by screws 241 that run through threaded opening 244 and act against the first and second end plates to press them against the central portion 216 and hold them in place by friction. Further, center portion 216 is further secured to outer shell 212 by bolts 232 running through holes 230 in center portion 216 and into threaded openings 246 in the bottom surface of central opening 248 of outer shell 212.

Similarly, the opposite mold half 310 shown in FIG. 12 comprises an outer shell 312 substantially as shown in FIGS. 2A-C, an inner mold assembly 314 having a center portion 316, a first end plate 318 and a second end plate 320. In some of these embodiments, center portion 316 may be formed using 3D printing. Center portion 316 comprises textured inner surface 326 and holes 330, as shown. As was the case in FIG. 11, outer shell 312 contains side threaded openings 334, which are sized to receive screws 348, bottom threaded openings 346 which are sized to receive bolts 332, injection ports 349, and alignment posts 350.

As was the case with the other side of the mold 210 shown in FIG. 11, in these embodiments the center portion 316 of the inner mold assembly 314 is a single piece and there is no separate mold insert. Also, in these embodiments, the inner mold assembly 314 is not secured together with bolts as shown in FIGS. 1, 3C-D, and 8A-B, before being secured to the outer shell 312. Instead, the first end plate 318 and second end plate 320 are held in place by screws 348 that run through threaded openings 334 and act against the first and second end plates 318, 320 to press them against the central portion 316 and hold them in place by friction. Further, center portion 316 is further secured to outer shell 312 by bolts 332 running through holes 330 in center portion 316 and into threaded openings 346 in the bottom surface of central opening 322 of outer shell 312.

In one or more embodiments, center portions 216, 316 are preferably fabricated by 3D printing, as set forth above. While first end plate 218, 318, second end plate 220, 320 can also be fabricated by 3D printing as set forth above, they are preferably fabricated from a metal, such as aluminum, steel or brass since these materials are more durable and these parts are not typically customized.

As will be apparent, alignment posts 350 in second mold half 310 are sized to be received with alignment openings 250 of first mold half 210 to align them for the molding process and to prevent lateral movement of either mold half 210, 310 with respect to the other. Mold halves 210 and 310 are further clamped together to prevent them from being pushed away from each other by the force of the resin entering the mold as is known in the art.

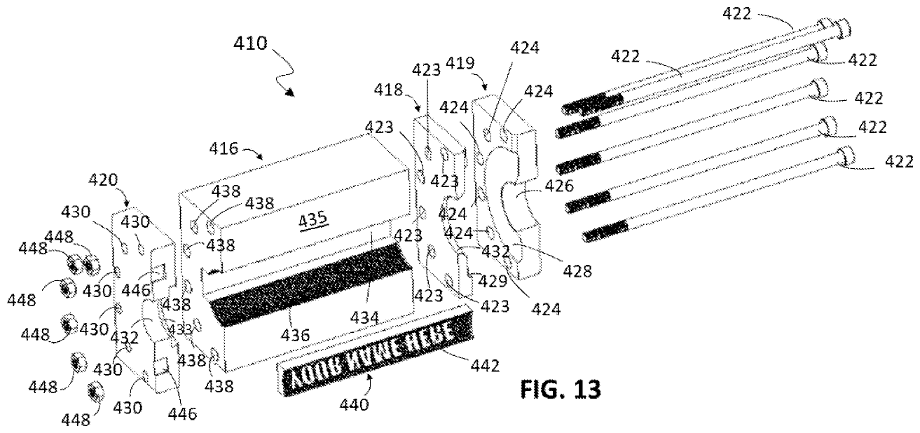

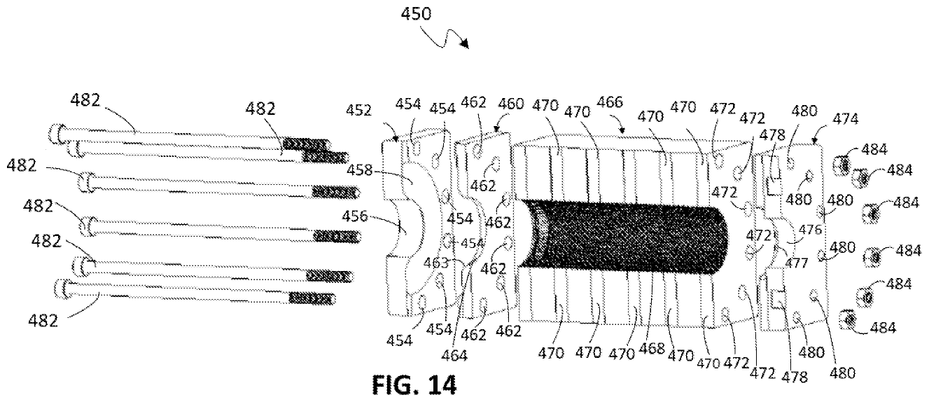

Another alternative embodiment is shown in FIGS. 13 and 14. FIGS. 13 and 14 show corresponding halves 410, 450 of a mold for generating a textured bicycle or motorcycle handlebar grip according to an alternative embodiment of the present invention. In the embodiments shown in FIGS. 13 and 14 no outer shell is used and closed (first) end of the center portion has been separated from the center portion as a separate part between the center portion and the first end plate. This structure is now referred to as the “inner” first end plate. This has the advantage of allowing the textured portion to be exchanged without changing the flange mold, which is now completely separate. So, turning to FIG. 13, first mold half 410 comprises a center portion 416, an inner first end plate 418, an outer first end plate 419, and a second end plate 420. As can be seen, outer first end plate 419 comprises holes 424, semicircular recess 426, and first inner flange mold portion 428. Inner first end plate 418 comprises holes 423, second inner flange mold portion 429 and a semicircular recess 432. Similarly, second end plate 420 comprises holes 430, semicircular recess 432 and slots 446.

Inner first end plate 418, outer first end plate 419, second end plate 420 can be made from any material having the necessary strength and heat tolerance using any suitable means known in the art. In some embodiments, one or more of the inner first end plate 418, outer first end plate 419, second end plate 420 may be formed of the photosensitive resin by 3D printing, as described above. In other embodiments, one or more of the inner first end plate 418, outer first end plate 419, second end plate 420 may be formed of a metal such as steel, brass, iron, aluminum, or other strong materials by any suitable method, such as welding, grinding, milling, CNC machining, metal 3D printing such as selective laser sintering (SLS) 3D printing, casting, or combinations thereof, as described above.

The center portion 416 in FIG. 13 comprises a slot 434, a front surface 435, a textured inner surface 436, holes 438, and a customized insert 440 having a textured surface 442, as set forth above. Finally, mold half 410 is held together by bolts 422, which pass through holes 424 in the outer first end plate 419, holes 423 of inner first end plate 418, holes 438 in center portion 416, and holes 430 of second end plate 420 and are received by threaded nuts 448, as shown in FIG. 13. It should be appreciated, however, that the mechanism for holding center portion 416, outer first end plate 419, inner first end plate 418, and second end plate 420 together is not particularly limited and any suitable mechanical fastener or combination thereof, may be used. In some embodiments, for example, holes 430 of second end plate 420 may be threaded and sized to receive and engage with bolts 422. In some other embodiments, the center portion 416, outer first end plate 419, inner first end plate 418, and second end plate 420 may be held together by one or more external clamps. In these embodiments, one or more rods may be inserted through holes 424 in the outer first end plate 419, holes 423 of inner first end plate 418, holes 438 in center portion 416, and holes 430 of second end plate 420 to ensure alignment of the center portion 416, outer first end plate 419, inner first end plate 418, and second end plate 420.

Similarly, the opposing mold half 450 in FIG. 14 comprises a center portion 466, an inner first end plate 460, an outer first end plate 452, and a second end plate 474. As can be seen, outer first end plate 452 comprises holes 454, semicircular recess 456, and first inner flange mold portion 458. Inner first end plate 460 comprises holes 462, second inner flange mold portion 463 and a semicircular recess 464. Similarly, second end plate 474 comprises holes 480, semicircular recess 476, outer flange mold portion 477, and slots 478 which are sized to receive a screwdriver or other similar tool to assist in separating the mold halves after molding. The center portion 466 comprises a textured inner surface 468 and holes 472, as set forth above. Finally, mold half 450 is held together by bolts 482, which pass through holes 454 in the outer first end plate 452, holes 462 of inner first end plate 460, holes 472 in center portion 466, and holes 480 of second end plate 474 and are received by threaded nuts 484, as shown in FIG. 14. Again, it should be appreciated, that the particular mechanism for holding center portion 466, outer first end plate 452, inner first end plate 460, and second end plate 474 together is not particularly limited and any suitable mechanical fastener, or combination thereof, may be used. In some embodiments, for example, holes 480 of second end plate 474 may be threaded and sized to receive and engage with bolts 482. In some other embodiments, center portion 466, outer first end plate 452, inner first end plate 460, and second end plate 474 may be held together by one or more external clamps. In these embodiments, one or more rods may be inserted through holes 454 in the outer first end plate 452, holes 462 of inner first end plate 460, holes 472 in center portion 466, and holes 480 of second end plate 474 to ensure alignment of the center portion 466, outer first end plate 452, inner first end plate 460, and second end plate 474.

In the embodiment shown in FIGS. 13 and 14, a rod or dowel (not shown) is inserted through tube 520, 521 to help keep it from losing its shape during the molding process. The rod or dowel is oriented so that the inner end portion of tube 520, 521 described below faces the semicircular recess 456 in the outer first end plate 452 of mold half 450. It is held in place between semicircular recesses 432 on mold half 410 and semicircular recess 476 in mold half 450. Tube 520, 521 abuts the second mold ends plates 420 and 474. The other end of the tube 520, 521, however, extends into semicircular recesses 426 and 456, where it is held in place when the mold is closed and clamped shut. As set forth above, the grips produced are consequently open ended and have a clean, flush ends without cutting. However, the other end of tubes 520, 521 does extend into semicircular recesses 426 and 456, where it is held in place between them. While also referred to as a “semicircular recess,” semicircular recess 432 in inner first end plate 418 of mold half 410 and semicircular recess 464 in inner first end plate 460 of mold half 450 are part of the mold form for the inner flange and are not used to support the rod or dowel carrying tube 520, 521. Because tube 520, 521 shown in the figures are all circular in cross section, the recesses in the outer shell and inner mold assembly are described herein as “semicircular” or “semi-circular” but the invention is not to be so limited. As should be apparent, these recesses can be any shape necessary to hold a rod and tube or other object upon which the grip is to be molded.

In one or more embodiments, center portions 416, 466 are preferably fabricated by 3D printing, as set forth above. While the inner first end plate 418, 460, outer first end plate 419, 452, second end plate 420, 474 can also be fabricated by 3D printing as set forth above, they are preferably fabricated from a metal, such as aluminum, steel or brass since these materials are more durable and these parts are not typically customized.

In use, mold halves 410, 450 are aligned with each other and clamped in place. In some embodiments, sets of interlocking structures, such as pins, posts, holes, openings, grooves, or slots may be present on the opposing faces of center portions 416 and 466 to prevent lateral movement and aid in alignment of mold halves 410, 450. In various embodiments, mold halves 410 and 450 are held together by clamps or similar mechanical fastening means, as is known in the art.

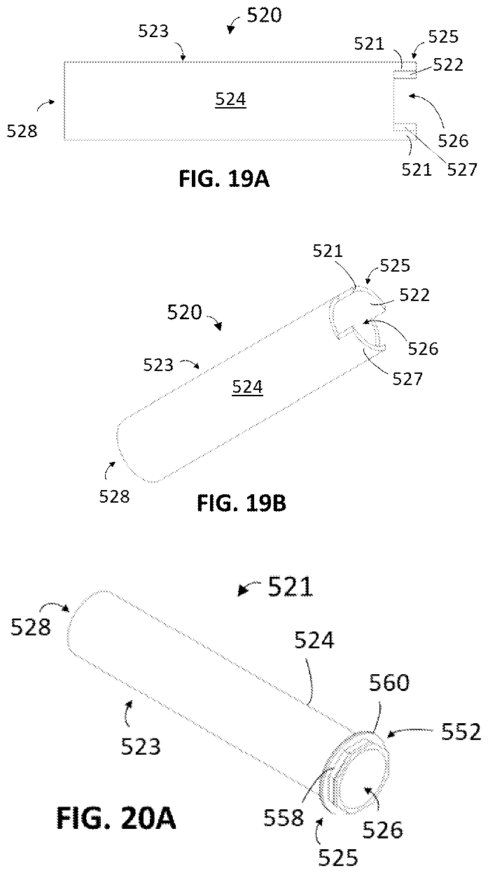

As set forth above, the embodiments of the present invention depicted in FIGS. 1-14 produce handles for bicycles, motorcycles, and other vehicles having similar types of handles of the types shown in FIGS. 15A-D and 16A-C. In one or more of these embodiments, the grip will be molded around a hollow plastic tube 520, 521, representative examples of which are shown in FIGS. 19A-B and 20A-D. In the molding process, these tubes are placed in the mold and held in place between the two inner mold assemblies. In the molds shown in FIGS. 1-9, for example, a rod or dowel (not shown) is inserted through tube 520, 521 (not shown) to help keep it from losing its shape during the molding process. The rod or dowel is oriented so that the inner end portion of tube 520, 521 faces the semicircular recess 36 in the outer shell 12 and held in place between the semicircular recesses 110 and a similar structure on the opposite half of the mold. Tube 520, 521 abuts the second end mold 20 and does not extend into semicircular recesses 110. As set forth above, the grips produced are consequently open ended and have a clean, flush outer ends without cutting. As set forth above, however, the other ends of tubes 520, 521 do extend into semicircular recess 92 where it is held in place between semicircular recess 92 and a corresponding structure on the other mold half. Because tube 520, 521 is shown in the figures as circular in cross section, the recesses in the outer shell and inner mold assembly are described herein as “semicircular” or “semi-circular” but the invention is not to be so limited. As should be apparent, these recesses can be any shape necessary to hold a tube or other object upon which the grip is to be applied in place and if necessary protrude from the mold shell.

The resin used will produce the grip is not particularly limited provided that it can be injection molded as set forth herein and may vary depending upon the type of grip being formed. The resin used to form the grip is preferably a thermoplastic elastomer such as thermoplastic vulcanizates, olefin thermoplastic vulcanizates, thermoplastic polyurethanes, styrene ethylene butadiene styrene(s) (SEBS), or styrenic block copolymers (SBCs), but may also include other rubber and rubber-like materials such as ethylene propylene diene monomer rubber (EPDM), natural rubber, foam, silicone, butyl “Kraton” rubber, etc., provided they are capable of being injection molded. In some embodiments, the resin will be a thermoplastic vulcanizate (TPV). In some embodiments, the resin will be a nylon-based, polyester-based or polypropylene-based thermoplastic vulcanizate. Thermoplastic vulcanizates (TPVs) are a very special class of thermoplastic elastomers prepared by dynamic vulcanization or cross-linking process, which involves the cross-linking of a rubber phase while it is being melt-mixed with a thermoplastic material at elevated temperature. TPVs such as NexPrene® TPV-35A-400 (TPE Solutions, Inc. (Shirley, MA)) provide the performance of vulcanizate rubber with the advantage of low-cost thermoplastic processing, are FDA compliant, and have a maximum service temperature of 275° F.

As will also be apparent, however, the resin used will have an injection temperature that does not exceed the maximum heat deflection temperature (HDT) of the polymer used to form the 3D printed mold insert and any other 3D printed parts. The resin used will also need to meet whatever mechanical and chemical requirements are mandated by the particular application. In one or more embodiments, the resin used to form the grip will have a melt temperature of from about 150° C. to 400° C. at the time of molding. In some embodiments, the resin used to form the grip will have a melt temperature of from about 150° C. to 400° C., in other embodiments, from about 200° C. to about 400° C., in other embodiments, from about 250° C. to about 400° C., in other embodiments, from about 300° C. to about 400° C., in other embodiments, from about 350° C. to about 400° C., in other embodiments, from about 150° C. to about 350° C., in other embodiments, from about 150° C. to about 300° C., in other embodiments, from about 150° C. to about 250° C., and in other embodiments, from about 150° C. to about 200° C. at the time of molding. In some of these embodiments, the resin used to form the grip will have a melt temperature of from about 190° C. to 230° C. at the time of molding. In some of these embodiments, the resin used will produce a grip having a maximum heat deflection temperature (HDT) of at least 150° C., in other embodiments, at least 200° C., in other embodiments, at least 250° C., and in other embodiments, at least 275° C. In some embodiments, the resin used will produce a molded grip having a dimensional accuracy about ±0.5% or less.

In some embodiments, the resin used will produce the grip will harden to form a material having a Shore A hardness of from about 20 to 60. In some embodiments, the resin used will produce the grip will harden to form a material having a Shore A hardness of from about 20 to 50, in other embodiments, from about 20 to about 45, in other embodiments, from about 20 to about 40, in other embodiments, from about 20 to about 35, in other embodiments, from about 20 to about 30, in other embodiments, from about 25 to about 60, in other embodiments, from about 35 to about 60, in other embodiments, from about 40 to about 60, and in other embodiments, from about 45 to about 60. In some embodiments, resin used will produce the grip will harden to form a material having a Shore A hardness of about 35 or 36. In some embodiments, the resin used to produce the grip will harden to form a material with a compression set at 100° C. for 22 hours of from about 5%to about 65%. In some embodiments the resin used will produce the grip will harden to form a material with a compression set at 125° C. for 72 hours of about 33% as measured by ASTM D395/ISO 815 standards.

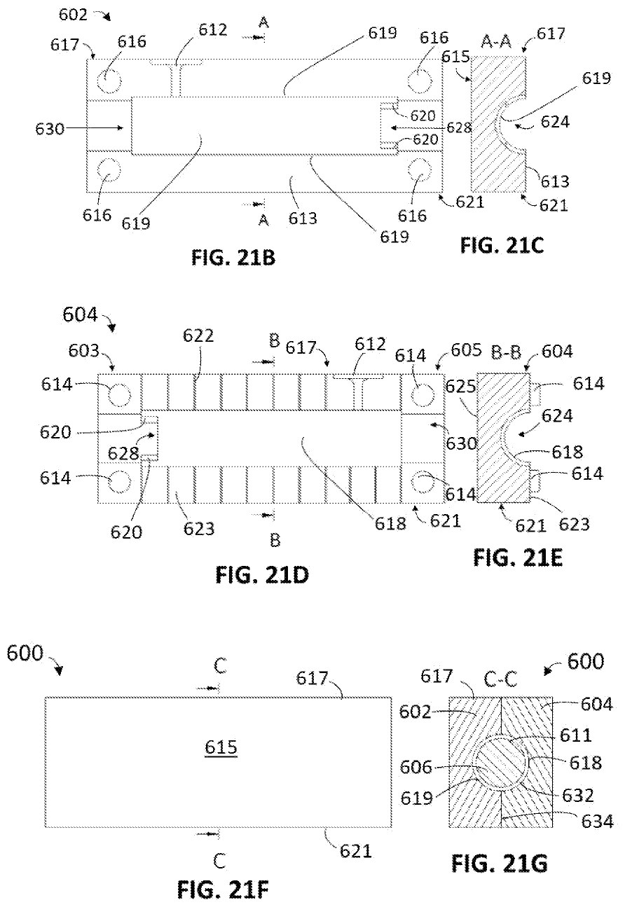

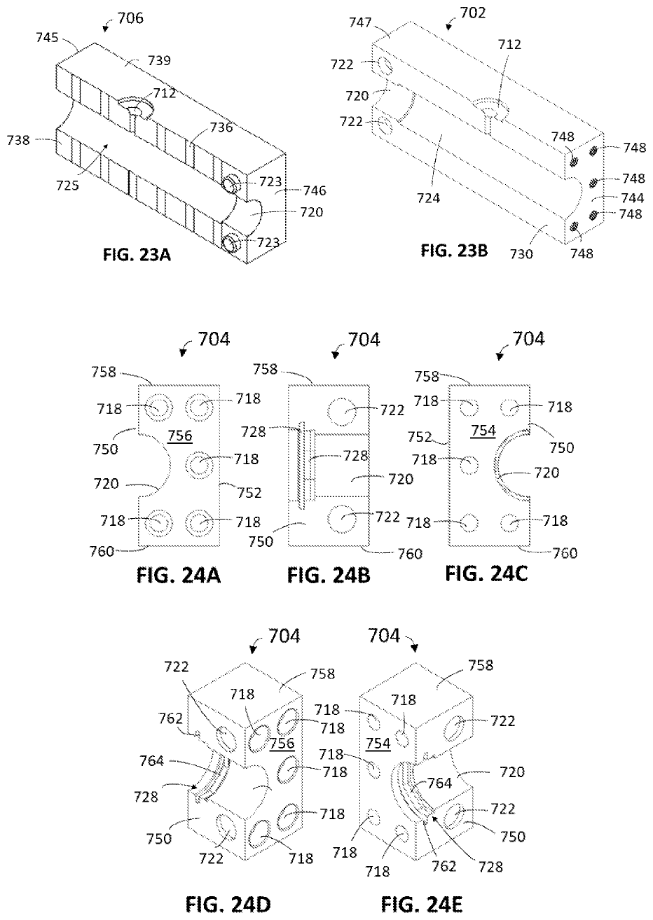

As set forth above, in some embodiments, the resin will be molded over a tube to form a grip having a hard inner portion comprising the tube and a softer outer portion applied using the molds described above. In other embodiments, a two-step process may be used to apply the grip directly to a handle, such as a tool or golf club. In these embodiments, a mold, such as the molds shown in FIGS. 21-24, is used to form the hard inner portion of the grip directly to the handle and then the softer outer portion of the grip is applied using a mold substantially as described above and shown in FIGS. 1-14. In these embodiments, as with overmolding in general, it is important that the resin made to form the hard inner portion of the grip is chemically and mechanically compatible with the resin used to form the softer outer portion of the grip. In some embodiments, the hard inner portion of the grip will be formed from polypropylene and the softer outer portion of the grip will be formed from a TPV. In these embodiments, a melt bond is formed between the two resins adhering them together.

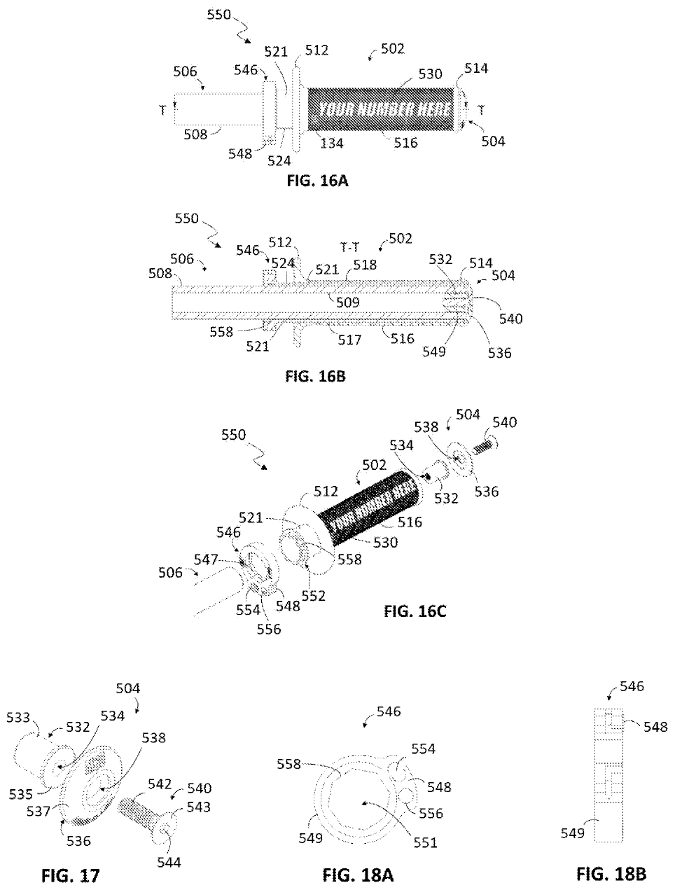

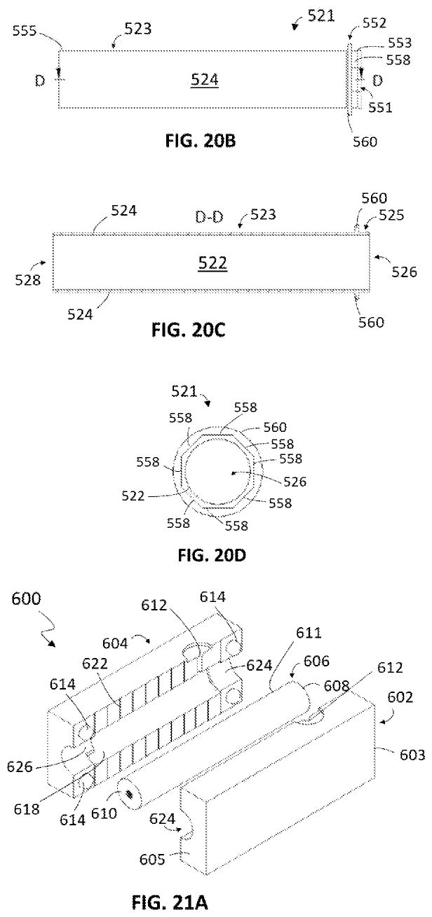

The tube 520 shown in FIGS. 19A-B is intended to fit over the surface upon which the grip is to be attached, where it will be clamped or adhered in place. In these embodiments, the tube is sized to fit over the end of a handlebar as shown in FIGS. 15A-D. In these embodiments, tube 520 will have a body portion 523, an inner end portion 525 having one or more tabs 521 that is preferably configured to interface with retaining ring 510, an inner surface 522, an outer surface 524, an inner end opening 526, and an outer end opening 528. In some other embodiments, the inner end portion 525 of tube 520 will be configured for use as a throttle tube and will mate with a throttle cam (see, FIGS. 20A-D). As will be appreciated by those of skill in the art, there are numerous cam interfaces used with motorcycles and other motorized devices with throttle controls on the handlebars. As a result, the particular configuration of the throttle cam interface 552 on the inner end portion 525 of tube 521 in the present invention is not particularly limited, and any suitable configuration may be used. In the embodiments shown in FIGS. 20A-D, the throttle cam interface 552 on the inner end portion 525 of tube 521 comprises flange 560 and a plurality of facets 558, which interface with a throttle cam 546 as shown in FIGS. 16A-C.

As set forth above, a handlebar assembly 500 made using the tubes 520 shown in FIGS. 19A-B. As shown in FIGS. 15A-D, handlebar assembly 500 comprises molded grip 502, end cap 504, handlebar 506, and retaining ring 510. As can be seen, molded grip 502 has an inner flange 512, and outer flange 514, a textured outer surface 516 optionally containing a name, design or logo 530 and is formed from tube 520 and outer molded portion 517. Handlebar 506 is a hollow tube having an outer surface 508 and an inner surface 509 and is usually, but need not be, operably connected to the steering mechanism of the vehicle or device.

The end cap 504 is best shown in FIGS. 15B-D, 16B-C and 17 and comprises a plug member 532 sized to fit within handlebar 506 and having an outer surface 533 and a threaded opening 534, a disc shaped member 536 having an outer surface 537, and a annular opening 538, and a bolt member sized and configured to be received within the threaded opening 534 in plug member 532 and has a threaded shaft 542, a flange 543, and a tool interface 544 configured to mate with a tool for driving the bolt The retaining ring 510 is best shown in FIGS. 15B-D and has a central opening 511, an inner surface 519 having one or more slots 513 configured to mate with the tab ends 527 of the tube 520, and a clamping portion (not shown) for securing the grip portion to handlebars 506.

A handlebar assembly 550 for use with a throttle tube made using the tube 521 as shown in FIGS. 20A-D, is shown in FIGS. 16A-C. In these embodiments, handlebar assembly 550 comprises a grip portion 502, an end cap 504, a handlebar 506, and a throttle cam 546. As can be seen, the end cap 504 and handlebar 506 are the same as shown in FIGS. 15A-D and 17 and the retaining ring 510 has been replaced with the throttle cam 546. Similarly, grip 502 is substantially the same as shown in FIGS. 15A-D except that tab ends 527 of tube 520 have been replaced with throttle interface 552. The throttle cam 546 is best shown in FIGS. 18A-B and comprises an outer surface 549, a central opening 551, an inner surface configured to mate with the facets 558 on the throttle interface 552 of tube 521, and a tab end 548 having a pull cable interface 556 and a return or “push” cable interface 554, which are operably connected to the throttle of the vehicle or other device being used.

In the embodiments shown in FIGS. 16A-C and 20A-D, the throttle interface 552 on the end portion 525 of tube 521 comprises a flange 560, which prevents tube 521 from sliding too far into or through the throttle cam 546 and/or too far in or out the throttle assemble of a motorcycle or dirt bike, and an octagonal end having 8 facets 558 that will act together against throttle cam 546, as is known in the art, to increase or decrease the throttle. The number of facets and, more broadly, the manner in which the end portion 525 of tube 521 interfaces with throttle cam 546 is not particularly limited, so long as the end portion 525 can act on throttle cam 546 in such a way that the throttle of the vehicle can be controlled by the rotation of tube 521 (and with it the entire grip) relative to handlebar 506. As will be understood, there are a variety of different types of throttle interfaces used and known in the art, and it is intended that the end portion 525 of tube 521 be configured to meet with the particular type of throttle cam 546 and throttle interface being used. One of ordinary skill in the art will be able obtain or fabricate a tube 521 having an end portion 525 with a throttle interface 552 configured to operably interface with a particular throttle cam without undue experimentation.

In another aspect, the present invention is directed to a system for making the customized grips shown above comprising the steps of: forming a mold for a grip, the mold having a first mold portion and second mold portion, wherein at least one of the first and second mold portions comprises a recessed area sized to receive a 3D printed mold insert reverse textured to form an outer surface of the grip; forming or obtaining a tube sized to fit within the outer mold, the tube having an inner surface tube and an outer surface upon which the grip is to be molded; designing an mold insert sized to fit within each one of the recessed areas and having an inner surface facing the recessed area of the first or second mold portion and an outer surface reverse textured to form textures, letters, numbers, or designs in or on the surface of the grip using a computer and printing the mold insert from a 3D printable material using a 3D printer; inserting an inner mold section into each one of the recessed areas in the first and second mold portions; inserting the tube between the first and second mold portions, closing the mold by joining first and second outer mold assemblies together over the tube thereby forming a cavity in which the grip will form; and injecting a liquid resin under pressure between the outer surface of the tube and the outer surface of the inner mold sections and then cooling or hardening the resin to form the grip.

In various embodiments, the step of forming a mold for a grip will entail constructing a mold assembly like those shown in FIGS. 1-14 and discussed in detail above. In one or more embodiments, the mold have a first outer shell portion and second outer shell portion and a first and second inner mold sized to fit with the first and second outer shell portions wherein at least one of the first and second inner mold portions comprises a recessed area sized to receive a 3D printed mold insert reverse textured to form an outer surface of the grip. In some embodiments, both the first and second inner mold portions will have a recessed area sized to receive a 3D printed mold insert reverse textured to form an outer surface of the grip. In one or more other embodiments, only one of the first and second inner mold portions will a recessed area sized to receive a 3D printed mold insert reverse textured to form an outer surface of the grip. In these embodiments, the other inner mold portion will have a front surface that is reverse textured to form the other outer surface of the grip.

The next step involves forming or obtaining a tube sized to fit within the outer mold which has an inner surface that will be secured to the handlebar or other handle to which the grip is applied and an outer surface upon which the grip is to be molded. In various embodiments, the tubes may be as shown in FIGS. 19A-B and 20A-D, and described below. The material used to form the tube is not particularly limited, but the material will preferably be compatible with and bond to the material used to form the softer, outer portion of the grip. Suitable materials may include, without limitation, polypropylene, polystyrene, nylon, polycarbonate, polyethylene, high-density polyethylene (HDPE), polyether ether ketone (PEEK), and combinations thereof. In one or more embodiments, the tube may be made by any suitable method, including, but not limited to, injection molding, extrusion, blow molding, and combinations thereof. In various embodiments, the tube will be injection molded from polypropylene.

Next, a mold insert sized to fit within each one of the recessed areas and having an outer surface reverse textured to form textures, letters, numbers, or designs in or on the surface of the grip is designed using a computer and then 3D printed from a 3D printable resin material using a 3D printer. As set forth above, the mold insert may be 3D designed using any suitable 3D modeling or 3D capable computer assisted design (CAD) software, such as SolidWorks™ (Dassault Systems SolidWorks Corp., Waltham, MA), Fusion 360™ (Autodesk Inc., San Francisco, CA), and/or proprietary software provided with the 3D printer being used. In some embodiments, the CAD models may be sliced digitally into layers using the 3D printer's software suite prior to manufacturing. The 3D printable CAD file generated is then sent to a 3D printer to generate the 3D printed mold insert. The 3D printable resin and the 3D printer used may be as set forth above. In some embodiments, the mold insert is 3D printed from a printable resin using a stereolithography (SLA) based Formlabs™ Form 2 3D Printer.

In some embodiments, the molds can be standardized so that it is possible to prepare a library of different mold inserts so that a variety of different designs can be made without the need to generate a new mold insert. In some embodiments, one customized mold insert may be designed with a client and the client allowed to select from a series of mold inserts having different styles and textures for the other side of the mold.

The 3D printed inner mold inserts are then inserted into each one of the recessed areas in the first and second inner mold portions, and then placed in the first and second outer shell, as shown in FIGS. 1-12 above. Next, the tube is inserted between the first and second inner mold portions, and the mold is closed over the tube, thereby forming a cavity in which the grip will be formed. Finally, a liquid resin, as described above, is injected into the mold under pressure between the outer surface of the tube or other structure upon which the grip is to be formed, and the outer surface of the inner mold sections to form the grip. The grip is then cooled and or hardening the resin to form the final grip.

As will be understood, the injection pressure will depend upon a variety of factors including the temperatures at various points in the process and complexity of the mold design. In some embodiments, the system for forming a customized grip of the present invention includes any one or more of the above referenced embodiments of the first aspect of the present invention wherein the step of injecting takes place at a pressure of from about 500 psi to about 20,000 psi. In some embodiments, the step of injecting takes place at a pressure of about 800 psi to about 20,000 psi, in other embodiments, from about 3,000 psi to about 20,000 psi, in other embodiments, from about 5,000 psi to about 20,000 psi, in other embodiments, from about 10,000 psi to about 20,000 psi, in other embodiments, from about 15,000 psi to about 20,000 psi, in other embodiments, from about 500 psi to about 15,000 psi, in other embodiments, from about 500 psi to about 12,000 psi, and in other embodiments, from about 500 psi to about 1,000 psi, in other embodiments, from about 500 psi to about 900 psi, in other embodiments, from about 800 psi to about 15,000 psi.

Similarly, the injection temperatures will depend upon a variety of factors including, but not limited to, the complexity of the mold, the melting point and other thermal properties of the polymer resin being used, the inherent viscosity of the liquid resin, the number of injection ports, the temperature of the mold, the number and size of the air vents, the injection pressure to be used, and the heat tolerances of the materials used to form the molds. One of ordinary skill in the art will be able to arrive at a suitable injection temperature without undue experimentation. In some embodiments, the step of injecting takes place at a liquid resin temperature of about 150° C. to about 400° C. measured at the nozzle. In some embodiments, the mold will be heated to a temperature of from about 25° C. to about 80° C. at the time of injection. In some embodiments, the mold will be heated to a temperature of about 50° C. at the time of injection. In some embodiments, the step of injecting takes place at a pressure of about 1250 psi and at a temperature of about 208° C.

In yet another embodiment, the present invention is directed to molds for forming the tube discussed above and shown in FIGS. 21-24 comprising: a body mold portion for forming the body of the tube, the body mold portion comprising a first body mold side and a second body mold side and having at least one injection port; one or more an interchangeable end mold portion for forming a tube end having a desired configuration, each interchangeable end mold portion having a first side and a second side; and a dowel; wherein the first body mold side and the first side of the interchangeable end mold portion are secured together to form a first mold half and the second body mold side and the second side of the interchangeable end mold portion are secured together to form a second mold half; and wherein the dowel is placed between the first mold half and the second mold half and secured together to form a completed mold.

Turning to FIGS. 21A-G, a mold assembly 600 for forming a tube for forming the grips described above is shown. The mold assembly 600 of FIGS. 21A-G forms a tube having the configuration shown in FIGS. 19A-B, above, but many other configurations are possible and within the scope of the invention. As can be seen in FIGS. 21A and 21F-G, mold assembly 600 is comprised of a first mold side 602 having a first end 603, a second end 605, a front surface 613, and a back surface 615; a second mold side 604; and a rod or dowel 606 that forms the hollow interior of the tube being formed. Mold assembly 600 also has a top side 617 and a bottom side 621. First mold side 602 of mold assembly 600 is best shown in FIGS. 21B-C and comprises injection port 612, a front surface 613, a back surface 615, alignment openings 616, a top surface 617, an inner surface 619, tab molds sections 620, a bottom surface 621, center opening for rod or dowel 624, a first end opening 628, and a second end opening 630.

Second mold side 604 of mold assembly 600 is best shown in FIGS. 21A, D-E and comprises injection port 612, a front surface 623, a back surface 625, alignment posts 614, a top surface 617, an inner surface 618, tab molds sections 620, a bottom surface 621, air vents 622, center opening for rod or dowel 624, a first end opening 628, and a second end opening 630. Rod or dowel 606 is best shown in FIGS. 21A and 21G. As can be seen, rod or dowel 606 has a first end 608, a second end 610, and an outer surface 611. The closed mold is shown in FIGS. 21 F-G. As can be seen, the two mold halves 602, 604 are closed around rod or dowel 606 and meet at seam 634. The tube is formed in the space 632 between the inner surface 619 of the first mold half 602, the inner surface 618 in the second mold half 604, and the outer surface 611 of the rod or dowel 606.

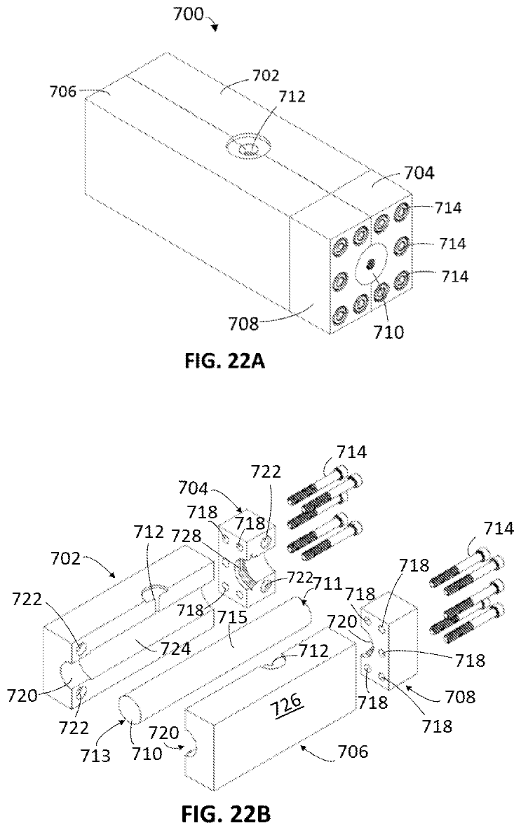

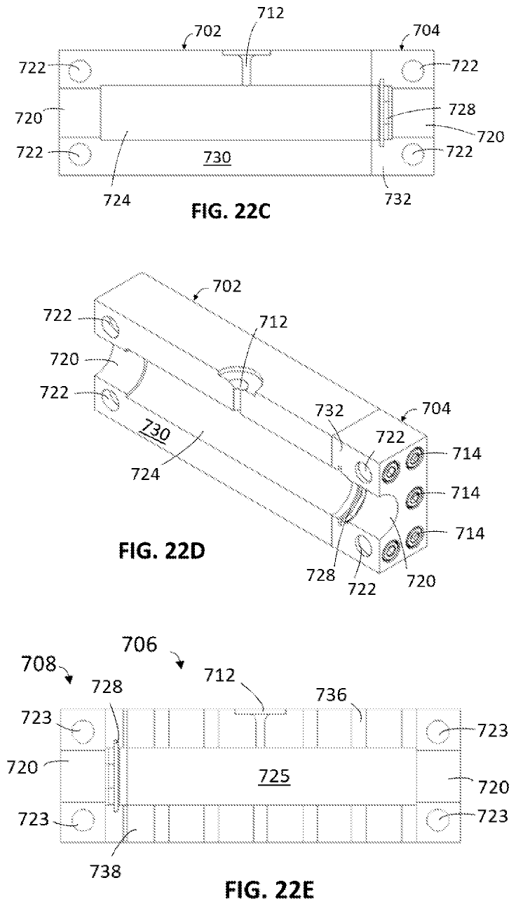

FIGS. 22A-E show an alternative mold assembly 700 for forming a tube useful in forming the grips described above. The mold assembly 700 of FIGS. 22A-E forms a tube having the configuration shown in FIGS. 20A-D, above, but many other configurations are possible and within the scope of the invention. As set forth above, there are a variety of different throttle cam interfaces in use for motorcycles, snowmobiles, All-terrain vehicles (ATVs), and other vehicles with the throttle on the handlebars. In some embodiments, the molds can be standardized so that it is possible to prepare a library of different end molds so that a throttle cam or other interface designs can be made without the need to generate a whole new mold.

As can be seen, mold assembly 700 comprises first body mold half 702, first end mold half 704, second body mold half 706, second end mold half 708, and rod or dowel 710. First body mold half 702 is best shown in FIGS. 22A-D and 23B and has an injection port 712, a semicircular dowel opening 720, alignment openings 722, an inner surface 724, a front surface 730, a first end 744, a second end 747, and threaded openings 748. Second body mold half 706 is best shown in FIGS. 22A-B, E and 23A and has an injection port 712, a semicircular dowel opening 720, alignment posts 723, inner surface 725, air vents 736, a front surface 738, a top surface 739, a first end 745, a second end 746, and threaded openings (not shown).

First end mold half 704 is best shown in FIGS. 22A-D and 24A-E and has openings 718, a semicircular dowel opening 720, alignment openings 722 an end mold section 728 comprising flange mold 762 and facet molds 764, a front surface 750, a back surface 752, an inner surface 754, an outer surface 756, a top surface 758, and a bottom surface 760. Second end mold half 708 is a mirror image of first end mold half 704 and is best shown in FIGS. 22A-B, E.

As can be seen, first body mold half 702 and first end mold half 704 are bolted together using bolts 714, inserted through openings 718 in first end mold half 704 and into threaded openings 748 in first body mold half 702 to form a first completed mold half. Similarly, second body mold half 706 and second end mold half 708 are bolted together using bolts 714, inserted through openings 718 in second end mold half 708 and into threaded openings (not shown) in first body mold half 706 to form a second completed mold half. Rod or dowel 710 is best shown in FIGS. 22A-B and comprises a first end 711, a second end 713, and an outer surface 715. The rod or dowel 710 in then placed between the first and second mold halves and held in place between the opposing semicircular dowel openings 720 on the first body mold 702 and the second body mold 706, and between the opposing semicircular dowel openings 720 on the first end mold 704 and the second end mold 708.

Finally, the mold is closed and optionally heated as is known in the art and a liquid resin is injected into the mold to form the tube. In various embodiments, the liquid resin will be as described above for the tube. In one or more embodiments, the liquid resin injected into the mold comprises polypropylene, ABS, or nylon, and combinations thereof. In one or more embodiments, the injection pressure is about 1,010 psi.

In light of the foregoing, it should be appreciated that the present invention significantly advances the art by providing a customizable handlebar grip that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

What is claimed is:

1. A system for forming a customized grip comprising:
A) forming a mold for a grip, said mold having a first mold portion and second mold portion, wherein at least one of said first and second mold portions comprises a recessed area sized to receive a 3D printed mold insert reverse textured to form an outer surface of the grip;
B) forming or obtaining a tube sized to fit within said mold, said tube having an inner surface and an outer surface upon which the grip is to be molded;
C) designing a mold insert sized to fit within at least one of said recessed areas and having a first surface facing the recessed area of said first or second mold portion and a second surface reverse textured to form textures, letters, numbers, or designs in or on the surface of the grip using a computer and printing said mold insert using a 3D printer;
D) inserting a mold insert into each one of said recessed areas in said first and second mold portions;
E) inserting said tube between the first and second mold portions, closing the mold by joining first and second mold portions together over said tube, thereby forming a cavity in which the grip will form; and
F) injecting a liquid resin under pressure between the outer surface of said tube and the second surface of said mold sections and then cooling or hardening the resin to form the grip.

2. The system for forming a customized grip of claim 1 further comprising an outer mold shell having a first and second outer mold shell half, each having an opening sized to receive one of said first mold portion and second mold portion.

3. The system for forming a customized grip of claim 2 wherein said outer mold shell is formed of a material selected from the group consisting of steel, aluminum, brass, metals, and combinations and alloys thereof.

4. The system for forming a customized grip of claim 2 wherein first mold portion and second mold portion are each secured within the opening in one of a first and second mold shell half sized to receive them.

5. The system for forming a customized grip of claim 1 wherein each one of said first mold portion and said second mold portion each comprise a first end plate, a center mold portion and a second end plate.

6. The system for forming a customized grip of claim 1 wherein said tube is sized to fit over a handlebar and engage a throttle cam on a handlebar of a vehicle.

7. The system for forming a customized grip of claim 1, wherein both first mold portion and second mold portion have a recessed area sized to receive a 3D printed mold insert which has been reverse textured to form an outer surface of the grip.

8. The system for forming a customized grip of claim 1, wherein one of the first mold portion and second mold portion have a recessed area sized to receive a 3D printed mold section textured to form an outer surface of the grip and the other of said first mold portion and second mold portion has an inner surface textured to form an outer surface of the grip.

9. The system for forming a customized grip of claim 1, further comprising forming a plurality of mold inserts having different textures, letters, numbers, or designs reverse textured their outer surface and selecting desired mold insert for use in the step of inserting (step D) from said plurality of mold inserts based upon user preference.

10. The system for forming a customized grip of claim 1 wherein said mold is formed from a material selected from the group consisting of aluminum, steel, brass, plastic, rubber, and combinations or alloys thereof.

11. The system for forming customized grips of claim 1 wherein said mold insert is 3D printed from a 3D printable resin comprising a polymer or copolymer selected from the group consisting of thermosetting plastics, photopolymer resins, photosensitive resins, and a combination thereof.

12. The system for forming customized grips of claim 1 wherein said mold insert has a flexural strength after post curing with heat and UV light of from about 95 MPa to about 125 MPa, as measured by ASTM D790-15.

13. The system for forming customized grips of claim 1 wherein said mold insert has a heat deflection temperature after post-curing with heat and UV light and under an applied force of 0.45 MPa of from about 140° C. to about a 460° C.

14. The system for forming customized grips of claim 1 wherein the resin forming said grip comprises a thermoplastic elastomer or a thermoplastic vulcanizate.

15. The system for forming a customized grip of claim 14 wherein the resin forming said grip is a thermoplastic vulcanizate comprising an ethylene propylene diene monomer rubber (EPDM) and polypropylene.

16. The system for forming a customized grip of claim 1 wherein the step of injecting takes place at a pressure of from about 800 psi to about 12,000 psi.

17. The system for forming a customized grip of claim 1 wherein one or more of said mold inserts further comprises a slot sized to receive an interchangeable insert, sized to fit within said slot, said interchangeable insert having a lower surface facing a bottom of said slot and an upper surface substantially contiguous with the inner surface of said one or more of said mold portion.

18. The system for forming a customized grip of claim 17 wherein the interchangeable insert is formed by a method selected from molding, casting, 3D printing, routing, engraving, CNC machining or a combination thereof.

19. The system for forming a customized grip of claim 1 wherein said liquid resin comprising a thermoplastic vulcanite polymer and said tube comprises polypropylene.

20. The system for forming a customized grip of claim 19 wherein said thermoplastic vulcanizate adheres to said tube when cooled or cured.

21. A mold for forming customized grips of claim 1 comprising:
A) a first mold half comprising a first outer mold shell and a first inner mold having a first 3D printed mold insert; and
B) a second mold half comprising a second outer mold shell and a second inner mold having a second 3D printed mold insert;
wherein the first and second 3D printed mold inserts each have an inner facing surface that is reverse textured to produce a texture or design in the customized grip; and
wherein said first and second mold inserts meet when the mold is in a closed arrangement to form the outer surface of the customized grip when resin is injected into the closed mold.

22. A mold for forming the tube of claim 1 comprising:
A) a body mold portion for forming the body of the tube, said body mold portion comprising a first body mold side and a second body mold side and having at least one injection port;
B) one or more an interchangeable end mold portion for forming a tube end having a desired configuration, each interchangeable end mold portion having a first side and a second side; and
C) a dowel;
wherein said first body mold side and said first side of said interchangeable end mold portion are secured together to form a first mold half and said second body mold side and said second side of said interchangeable end mold portion are secured together to form a second mold half; and
wherein the dowel is placed between said first mold half and said second mold half and secured together to form a completed mold.
